(19) United States
(12) Patent Application Publication
(10) Pub. No.: US 2024/0100732 A1
(43) Pub. Date: Mar. 28, 2024

(54) ROUTER

(71) Applicant: MILWAUKEE ELECTRIC TOOL CORPORATION, Brookfield, WI (US)

(72) Inventors: Peter Roloff, Pewaukee, WI (US); James C. Sitter, Milwaukee, WI (US); Leonard F. Mikat-Stevens, Glendale, WI (US); Eric K. Farrington, Grafton, WI (US); Jack Glennon, Milwaukee, WI (US); Daniel J. Tomcheck, Denmark, WI (US); Caleb M. Schober, Milwaukee, WI (US); David Hoffman, Grayslake, IL (US)

(21) Appl. No.: 18/474,635

(22) Filed: Sep. 26, 2023

Related U.S. Application Data
(60) Provisional application No. 63/410,514, filed on Sep. 27, 2022.

(51) Int. Cl. B27C 5/10

(52) U.S. Cl. CPC B27C 5/10

(57) ABSTRACT

The present disclosure is directed to a power tool including a motor housing and an electric motor situated within the motor housing. The electric motor is configured to provide rotational energy to rotate an output device of the power tool about an output axis. The power tool also includes a cover configured to cover at least a portion of a surface of the motor housing that faces the output device. The power tool further includes a first lighting device located within the cover and a second lighting device located within the cover. The first lighting device and the second lighting device are located around the output axis and are separated from each other by at least 130 degrees about the output axis. The power tool also includes first power wires configured to provide power to the first lighting device from a power source of the power tool.

### CROSS-REFERENCE TO RELATED APPLICATIONS

This application claims priority to co-pending U.S. Provisional Patent Application No. 63/410,514, filed Sep. 27, 2022, the entire content of which is hereby incorporated by reference.

### FIELD OF THE DISCLOSURE

The disclosure relates generally to hand-held power tools and kits, and more particularly to routers and router kits.

### BACKGROUND OF THE DISCLOSURE

Routers are used to drill into a material, often wood, to cut rounded edges, make indented cuts, trace patterns, and make other designs in the material. Such routers include both fixed base routers and plunge routers. Some of these existing routers include a base and a motor assembly removably connected to the base

### SUMMARY OF THE DISCLOSURE

The present disclosure provides, in one aspect, a router including a motor unit. The motor unit includes a housing including a lower housing portion coupled to an upper housing portion. The lower housing portion includes an open end having a rim that defines an opening, a partially closed end opposite the open end, and a cylindrical wall extending between the open end and the partially closed end. The motor unit also includes an electric motor situated within the housing and configured to provide rotational energy to rotate a tool holder about an output axis. The rim defines a straight reference plane, and the electric motor is positioned within the lower housing portion entirely on one side of the straight reference plane.

The present disclosure provides, in another aspect, a router including a motor unit, a first base, and a second base. The motor unit includes a housing including a battery receiving portion configured to selectively and removably couple to a battery pack. The motor unit also includes a brushless direct current (BLDC) motor situated within the housing and configured to provide rotational energy to rotate an output device of the motor unit about an output axis. The first base is configured to removably receive the motor unit and support the motor unit above a workpiece. The first base includes a first lower base portion and an annular sleeve. The second base is configured to removably receive the motor unit and support the motor unit above a workpiece. The second base includes a second lower base portion, a base support component, and a guide post coupling the second lower base portion to the base support component.

The present disclosure provides, in another aspect, a router including a motor unit and a base. The motor unit includes a housing including a battery receiving portion configured to selectively and removably couple to a battery pack. The motor unit also includes a brushless direct current (BLDC) motor situated within the housing and configured to provide rotational energy to rotate an output device of the motor unit about an output axis. The base is configured to removably receive the motor unit and support the motor unit above a workpiece. The base includes a first lower base portion and an annular sleeve. The battery pack has a nominal voltage of less than 21 volts, and the BLDC motor is configured to output at least 1800 W in response to receiving power from the battery pack.

The present disclosure provides, in another aspect, a power tool including a motor housing and an electric motor situated within the motor housing. The electric motor is configured to provide rotational energy to rotate an output device of the power tool about an output axis. The power tool also includes a cover configured to cover at least a portion of a surface of the motor housing that faces the output device. The power tool further includes a first lighting device and a second lighting device each located within the cover. The first lighting device and the second lighting device are separated from each other by at least 130 degrees about the output axis. The power tool also includes first power wires configured to provide power to the first lighting device from a power source of the power tool.

The present disclosure provides, in another aspect, a power tool including a motor housing including a first end and a second end opposite the first end, the second end configured to be an output end of the power tool. The power tool also includes a brushless direct current (BLDC) motor situated within the motor housing. The BLDC motor is configured to provide rotational energy to rotate an output device of the power tool about an output axis. A first end of the BLDC motor is located closer to the output device than a second end of the BLDC motor. The power tool further includes a first printed circuit board (PCB) positioned adjacent to the second end of the BLDC motor, the first PCB including at least one magnetic sensor and a plurality of power switching elements, the plurality of power switching elements configured to control whether power is provided to the BLDC motor. The power tool also includes a second PCB electrically connected to the first PCB. The second PCB includes a disconnect device configured to interrupt electric power to the BLDC motor. A first surface of the first PCB on which (i) the magnetic sensor, (ii) at least one of the plurality of power switching elements, or (iii) both (i) and (ii) are mounted is approximately parallel to a second surface of the second PCB on which the disconnect device is mounted. The first PCB is located between the BLDC motor and the second PCB in a direction parallel to the output axis.

The present disclosure provides, in another aspect, a power tool including a motor housing including a first end and a second end opposite the first end, the second end configured to be an output end of the power tool. The power tool also includes a brushless direct current (BLDC) motor situated within the motor housing. The BLDC motor is configured to provide rotational energy to rotate an output device of the power tool about an output axis. A first end of the BLDC motor is located closer to the output device than a second end of the BLDC motor. The power tool further includes a first printed circuit board (PCB) positioned adjacent to the second end of the BLDC motor, the first PCB including at least one magnetic sensor and a plurality of power switching elements, the plurality of power switching elements configured to control whether power is provided to the BLDC motor. The power tool also includes a fuse holder mounted to the first PCB and located on an opposite side of the first PCB than the BLDC motor. The fuse holder includes a plurality of tabs that protrude from the fuse holder approximately parallel to the output axis in a direction away from the BLDC motor. The plurality of tabs hold a fuse in place. The fuse is configured to interrupt electric power to the BLDC motor in response to a current flowing through the fuse that exceeds a first current limit.

The present disclosure provides, in another aspect, a power tool including a housing, an electric motor situated within the housing, a lighting device coupled to the housing, and a two-action switch assembly. The two-action switch assembly includes a slider slidably coupled to the housing, a biasing member biasing the slider in a first direction, a switch operable to activate at least one of the electric motor and the lighting device, and an actuator. The actuator is coupled to the housing and to the slider and movable relative to the housing from an off position to a first actuated position along a second direction opposite to the first direction. The actuator is further pivotable relative to the housing from the first actuated position to a second actuated position. The actuator includes a button portion and an elongated arm. The elongated arm actuates the switch in response to the actuator pivoting from the first actuated position to the second actuated position.

The present disclosure provides, in another aspect, a power tool including a housing, an electric motor situated within the housing, a lighting device coupled to the housing, and a two-action switch assembly. The two-action switch assembly includes a switch operable to activate at least one of the electric motor and the lighting device, a slider slidably coupled to the housing, a biasing member biasing the slider in a first direction, and an actuator. The actuator is coupled to the housing and to the slider and configured to actuate the switch. The actuator is movable relative to the housing from an off position to a first actuated position along a second direction opposite to the first direction. The actuator is further pivotable relative to the housing from the first actuated position to a second actuated position. The slider moves in the second direction in response to the actuator moving from the off position to the first actuated position.

The present disclosure provides, in another aspect, a power tool including a housing, an electric motor situated within the housing, a lighting device coupled to the housing, and a two-action switch assembly. The two-action switch assembly includes a first switch operable to activate the lighting device, a second switch operable to activate the electric motor, a slider slidably coupled to the housing and configured to actuate the first switch, a biasing member biasing the slider in a first direction, and an actuator. The actuator is coupled to the housing and to the slider and configured to actuate the second switch. The actuator is movable relative to the housing from an off position to a first actuated position along a second direction opposite to the first direction. The actuator is further pivotable relative to the housing from the first actuated position to a second actuated position.

The present disclosure provides, in another aspect, a power tool including a housing including a lower housing portion coupled to an upper housing portion. The lower housing portion includes an open end having a rim that defines an opening, a partially closed end opposite the open end, a cylindrical wall extending between the open end and the partially closed end, and a shaft mount portion protruding laterally outward from a side of the rim at the open end. The shaft mount portion defines a cylindrical recess and an aperture. The power tool also includes an electric motor situated within the housing and configured to provide rotational energy to rotate a tool holder about an output axis. The power tool further includes a depth adjustment shaft coupled to the housing and extending through the aperture. The power tool also includes a bushing received into the cylindrical recess and positioned between the shaft mount portion and the depth adjustment shaft.

The present disclosure provides, in another aspect, a router including a motor unit and a base. The motor unit includes a housing including a lower housing portion coupled to an upper housing portion. The lower housing portion includes an open end having a rim that mates with the upper housing portion. The lower housing portion also includes a first shaft mount portion protruding laterally outward from a side of the rim at the open end, the first shaft mount portion defining a first shaft aperture. The motor unit also includes an electric motor situated within the housing and configured to provide rotational energy to rotate a tool holder about an output axis. The motor unit further includes a depth adjustment shaft coupled to the housing and extending through the first shaft aperture. The base is configured to removably receive the motor unit and support the motor unit above a workpiece. The base includes a depth adjustment member configured to engage the depth adjustment shaft to effect movement of the motor unit relative to the base. The upper housing portion includes a second shaft mount portion that defines a second shaft aperture that receives the depth adjustment shaft.

The present disclosure provides, in another aspect, a power tool including a housing including a lower housing portion coupled to an upper housing portion. The power tool also includes an electric motor situated within the housing, the electric motor including an output shaft, a rotor affixed to the output shaft, and a stator affixed to the housing, the electric motor configured to provide rotational energy to rotate a tool holder about an axis of the output shaft. The power tool further includes a mount plate coupled to the stator and including a bearing mount portion that defines a cylindrical recess, the bearing mount portion having a closed end and an open end that defines an opening. The power tool also includes a bearing received into the cylindrical recess and supporting the output shaft for rotation about the axis relative to the mount plate. The power tool further includes a seal member received within the cylindrical recess and positioned between the bearing mount portion and the output shaft and between the bearing and the opening.

The present disclosure provides, in another aspect, a power tool including a housing including a lower housing portion coupled to an upper housing portion. The power tool also includes an electric motor situated within the housing, the electric motor including an output shaft, a rotor affixed to the output shaft, and a stator affixed to the housing, the electric motor configured to provide rotational energy to rotate a tool holder about an axis of the output shaft. The power tool further includes a bearing support member coupled to the housing and including a bearing mount portion at least partially defined by an annular wall, the bearing mount portion configured to receive a bearing that supports the output shaft for rotation about the axis relative to the bearing support member. The power tool also includes a plurality of damping elements positioned between the bearing and the annular wall. The damping elements are configured to dampen vibrations transmitted between the bearing and the bearing support member.

The present disclosure provides, in another aspect, a power tool including a housing including a lower housing portion coupled to an upper housing portion. The power tool also includes an electric motor situated within the housing, the electric motor including an output shaft, a rotor affixed to the output shaft, and a stator affixed to the housing, the electric motor configured to provide rotational energy to rotate a tool holder about an axis of the output shaft. The power tool further includes a bearing support member coupled to the housing and including a bearing mount portion configured to receive a bearing that supports the output shaft for rotation about the axis relative to the bearing support member. The power tool also includes a plurality of damping elements configured to dampen vibrations transmitted between the bearing and the bearing support member. The bearing mount portion defines a plurality of recesses opening toward the axis and receiving the plurality of damping elements.

The present disclosure provides, in another aspect, a track adapter configured to couple a power tool to a guide track. The track adapter includes an adapter plate configured to slidably couple to the guide track for sliding movement relative to the guide track along a first axis. The track adapter also includes a guide rod slidably supported by the adapter plate for sliding movement relative to the adapter plate along a second axis that is perpendicular to the first axis. The track adapter further includes a micro-adjust shaft coupled to the guide rod and to the adapter plate and rotatable to effect movement of the guide rod along the second axis. The track adapter also includes a measurement rod coupled to the guide rod and an indicator coupled to the measurement rod. The indicator is configured to indicate a distance travelled by the guide rod relative to the adapter plate along the second axis in response to a rotation of the micro-adjust shaft.

The present disclosure provides, in another aspect, a track adapter configured to couple a power tool to a guide track. The track adapter includes an adapter plate configured to slidably couple to the guide track for sliding movement along a first axis. The track adapter also includes a guide rod slidably supported by the adapter plate for sliding movement relative to the adapter plate along a second axis that is perpendicular to the first axis. The track adapter further includes a rod plate affixed to an end of the guide rod. The track adapter also includes an attachment rod affixed to the rod plate and configured to selectively and removably couple to the power tool.

The present disclosure provides, in another aspect, track adapter configured to couple a power tool to a guide track. The track adapter includes an adapter plate configured to slidably couple to the guide track for sliding movement along a first axis. The track adapter also includes a guide rod slidably supported by the adapter plate for sliding movement relative to the adapter plate along a second axis that is perpendicular to the first axis. The track adapter further includes a micro-adjust shaft rotatable to effect movement of the guide rod along the second axis. The track adapter also includes a carrier plate coupling the micro-adjust shaft to the guide rod such that the guide rod is selectively translatable relative to the carrier plate along the second axis.

Other aspects of the disclosure will become apparent by consideration of the detailed description and accompanying drawings.

### BRIEF DESCRIPTION OF THE DRAWINGS

FIG. 1 illustrates a perspective view of a router including a motor unit, a plunge base, and a fixed base, according to an embodiment of the disclosure.

FIGS. 2 and 3 illustrate perspective views of the motor unit of FIG. 1.

FIG. 4 illustrates a cross-sectional view of the motor unit of FIG. 1, taken along line 4-4 of FIG. 2.

FIG. 5 illustrates a partially exploded perspective view of the motor unit of FIG. 1.

FIG. 6 illustrates a detail view of a portion of the cross-sectional view of FIG. 4.

FIG. 7A illustrates a detail view of another portion of the cross-sectional view of FIG. 4.

FIGS. 7B and 7C illustrate perspective views of a mount plate of the motor unit of FIG. 1.

FIG. 7D is a partial cross-sectional view illustrating portions of a motor unit according to another embodiment.

FIG. 7E illustrates a perspective view of portions of the motor unit of FIG. 7D.

FIG. 7F illustrates an exploded perspective view of the portions of the motor unit shown in FIG. 7E.

FIGS. 8 and 9 illustrate perspective views of a dual-action switch assembly of the motor unit of FIG. 1.

FIG. 10 illustrates a cross-sectional view of the switch assembly of FIG. 8, taken along line 10-10 of FIG. 8 and showing the switch assembly in an off position.

FIG. 11 illustrates a bottom view of the switch assembly of FIG. 8 in the off position.

FIG. 12 illustrates a cross-sectional view of the switch assembly of FIG. 8, taken along line 10-10 of FIG. 8 and showing the switch assembly in a first actuated position.

FIG. 13 illustrates a bottom view of the switch assembly of FIG. 8 in the first actuated position.

FIG. 14 illustrates a side view of the switch assembly of FIG. 8 in a second actuated position.

FIG. 15 illustrates a cross-sectional view of the switch assembly of FIG. 8, taken along line 10-10 of FIG. 8 and showing the switch assembly in the second actuated position.

FIG. 16 illustrates a cross-sectional view of a dual-action switch assembly according to another embodiment of the disclosure.

FIG. 17 illustrates a cross-sectional view of a dual-action switch assembly according to yet another embodiment of the disclosure.

FIG. 18A illustrates a perspective view of the fixed base of FIG. 1.

FIG. 18B illustrates a dust chute operable with each of the plunge base and the fixed base of FIG. 1.

FIG. 19 illustrates a partial perspective cross-sectional view of the fixed base of FIG. 1, taken along line 19-19 of FIG. 18A.

FIG. 20 illustrates a partially exploded perspective view of portions of the fixed base of FIG. 1.

FIGS. 21 and 22 illustrate perspective views of portions of the fixed base of FIG. 1.

FIG. 23 illustrates a perspective view of the plunge base of FIG. 1.

FIG. 24 illustrates a perspective view of a guide track assembly, including a guide track and a track adapter, operable with the router of FIG. 1.

FIG. 25 illustrates a perspective view of the track adapter of FIG. 24.

FIG. 26 illustrates a top view of the track adapter of FIG. 24.

FIG. 27 illustrates a top view of a track adapter according to another embodiment of the disclosure.

FIG. 28 illustrates a top view of a track adapter according to yet another embodiment of the disclosure.

FIG. 29 illustrates a perspective view of a power tool, according to some embodiments.

FIG. 30A illustrates a front view of an output end of the power tool of FIG. 29, according to some embodiments.

FIG. 30B illustrates an exploded view of the output end of a motor housing of the power tool of FIG. 29 with a cover removed from the motor housing, according to some embodiments.

FIG. 30C illustrates a rear perspective view of the cover of FIG. 30B, according to some embodiments.

FIG. 31A illustrates a front perspective view of a lens of the power tool of FIG. 29, according to some embodiments.

FIG. 31B illustrates a side perspective view of the lens of FIG. 31A, according to some embodiments.

FIG. 31C illustrates a rear perspective view of the lens of FIG. 31A, according to some embodiments.

FIG. 32A illustrates a cross-sectional view of the power tool of FIG. 29, according to some embodiments.

FIG. 32B illustrates a rear perspective view of a motor housing of the power tool of FIG. 29, according to some embodiments.

FIG. 32C illustrates a rear perspective view of the power tool of FIG. 29, according to some embodiments, with the motor housing of FIG. 32B removed to allow components within the motor housing to be visible.

FIG. 33A illustrates another perspective view of the power tool of FIG. 29, according to some embodiments, with the motor housing of FIG. 32B removed and with a portion of a clamshell housing removed.

FIG. 33B illustrates a perspective view of a first printed circuit board (PCB) and a second PCB of the power tool of FIG. 29, according to some embodiments.

FIG. 33C illustrates a rear view of the power tool of FIG. 29, according to some embodiments, with a housing removed and some other components of the power tool removed to allow the PCBS of FIG. 33B to be visible.

FIG. 33D illustrates another rear view of the power tool of FIG. 29 similar to the rear view of FIG. 33C but with the second PCB also removed to make the first PCB more visible, according to some embodiments.

FIG. 34A illustrates a partial cutaway view of the power tool of FIG. 29, according to some embodiments, with a clamshell housing and components housed therein removed.

FIG. 34B illustrates a perspective view of a fuse holder of the power tool of FIG. 34A, according to some embodiments.

FIG. 35 illustrates a perspective view of the power tool of FIG. 29, according to some embodiments, with a clamshell housing and motor housing removed.

FIG. 36 illustrates a block diagram of the power tool of FIG. 29, according to some embodiments.

Before any embodiments of the disclosure are explained in detail, it is to be understood that the disclosure is not limited in its application to the details of embodiment and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

For simplicity and illustrative purposes, the present disclosure is described by referring mainly to an exemplary embodiment thereof. In the following description, numerous specific details are set forth in order to provide a thorough understanding of the present disclosure. However, it will be readily apparent to one of ordinary skill in the art that the present disclosure may be practiced without limitation to these specific details.

Throughout this application, the term “approximately” may be used to describe the dimensions of various components and/or relationships between locations of components. In some situations, the term “approximately” means that the described dimension/relationship is within 1% of the stated value, within 5% of the stated value, within 10% of the stated value, or the like. When the term “and/or” is used in this application, it is intended to include any combination of the listed components. For example, if a component includes A and/or B, the component may include solely A, solely B, or A and B.

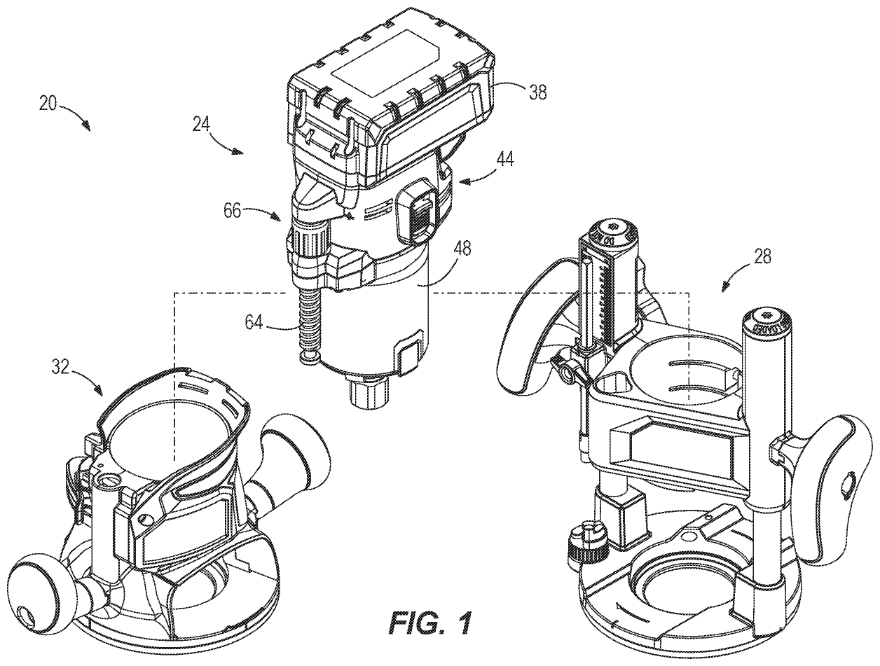

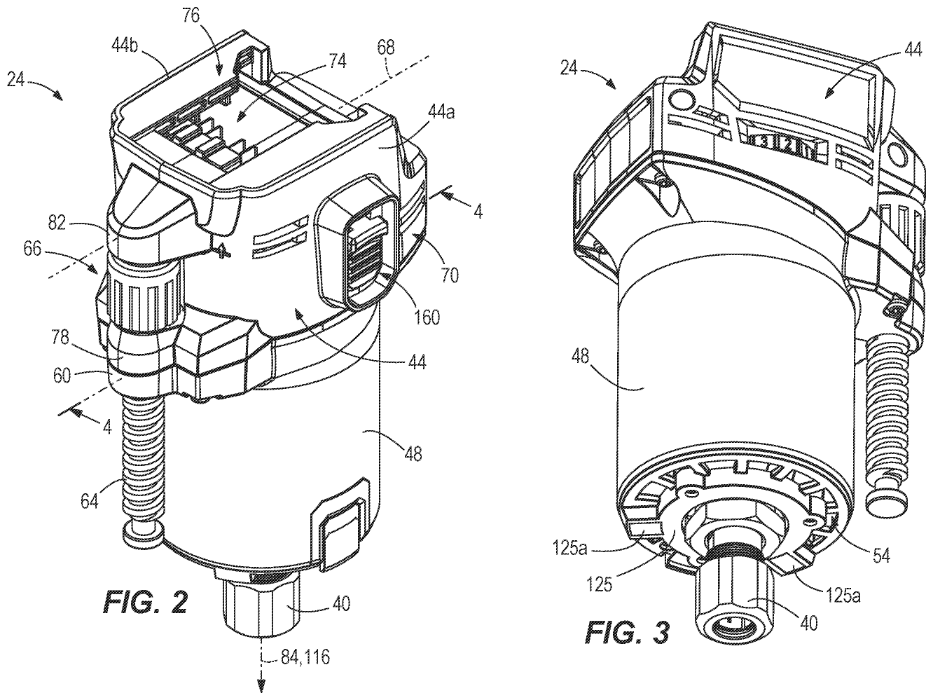

FIG. 1 illustrates a router 20 according to an embodiment of the present disclosure. The router 20 includes a motor unit 24 removably supported by a plunge base 28 or a fixed base 32. With reference to FIG. 2, the motor unit 24 is supportable by and usable with each of the plunge base 28 and the fixed base 32. The motor unit 24 is interchangeable between the plunge base 28 and the fixed base 32 to provide a router kit (described in more detail below).

### The Motor Unit

Referring now to FIGS. 1, 2, and 4, the motor unit 24 supports a motor 36 and associated components. The motor 36 can be electrically connected to a variety of power sources, such as an AC or DC power source. In the illustrated embodiment, the motor 36 is a brushless, direct-current (BLDC) motor and connects to a DC power source such as a removable and rechargeable battery pack 38. The motor 36 includes an output shaft 39, and a tool holder 40 is connected to or formed with the shaft 39 and is adapted to support a tool element (e.g., a router bit and the like; not shown). In the illustrated embodiment, the tool holder 40 is a collet. In other embodiments, the tool holder 40 can be any other device or structure suitable to support a tool element for this type of application. The motor 36 is operable to rotate the tool element to cut a workpiece.

With reference to FIGS. 2-5, the motor unit 24 is generally vertically oriented and includes an upper housing portion 44 and a lower housing portion 48. The lower housing portion 48 has a generally cylindrical outer surface and is adapted to be removably inserted into either the plunge base 28 or the fixed base 32. The lower housing portion 48 is generally barrel-shaped and includes a cylindrical outer wall 50, an open end 52, and a partially closed end 54. The open end 52 includes a rim 56 that defines an opening 58. A protruding section, or first shaft mount portion 60, protrudes laterally outward from one side of the rim 56 at the open end 52 of the lower housing portion 48. The first shaft mount portion 60 defines a first shaft aperture 62 that receives a depth adjustment shaft 64, which is also part of a depth adjustment mechanism 66, as described in greater detail below.

The upper housing portion 44 includes two clamshell halves 44a, 44b which, in the illustrated embodiment, are formed from resin and joined together along a parting line 68. The upper housing portion 44 includes an open end 70 that defines an opening 72. The open end 70 of the upper housing portion 44 mates with and couples to the open end 52 of the lower housing portion 48. The upper housing portion 44 also includes a battery receiving portion 74 that selectively couples to the battery pack 38 in a removable manner. The battery receiving portion 74 is formed at a top end 76 of the upper housing portion 44 that is located opposite from the open end 70.

The battery pack 38 includes a plurality of battery cells (not shown), which are electrically connected to provide the desired output (e.g., nominal voltage, current capacity, etc.) of the battery pack 38. The motor 36 receives power from the battery pack 38 when the battery pack 38 is coupled to the battery receiving portion 74. The battery pack 38 may have a nominal voltage of 18 Volts (V). In other embodiments, the battery pack 38 can have a nominal voltage of at least about 12 V up to about 24 V. In further embodiments, the battery pack 38 can have a nominal voltage of at least about 16 V up to about 21 V. During operation of the motor unit 24, the motor 36 can receive power from the battery pack 38 and output about 2175 Watts (W) (i.e., 2.9167 Horsepower (HP)). In further embodiments, the motor 36 can output over 1800 W when drawing power from the battery pack 38 having a nominal voltage of at least about 16 V up to about 21 V.

With reference to FIGS. 2-6, the upper housing portion 44 further includes a protruding section, or second shaft mount portion 78, that protrudes laterally outward from one side of the open end 70. The second shaft mount portion 78 defines a second shaft aperture 80 that aligns with the first shaft aperture 62 and that also receives the depth adjustment shaft 64. In the illustrated embodiment, portions of the second shaft mount portion 78 are formed by each of the clamshell halves 44a, 44b, and the second shaft aperture 80 is defined between the clamshell halves 44a, 44b.

The upper housing portion 44 further includes another protruding section, or third shaft mount portion 82, that protrudes laterally outward at the same side of the upper housing portion 44 as the second shaft mount portion 78. The third shaft mount portion 82 faces toward the second shaft mount portion 78 and is spaced apart from the second shaft mount portion 78 in a vertical direction (i.e., along a direction of a longitudinal axis 84 of the motor unit 24). A recess or gap 86 is defined between the second and third shaft mount portions 78, 82. A third shaft aperture 88 is defined in the third shaft mount portion 82 and opens in a direction facing toward the second shaft mount portion 78. The third shaft aperture 88 is aligned with the first and second shaft apertures 62, 80 along the vertical direction, and receives an upper end portion 90 of the depth adjustment shaft 64.

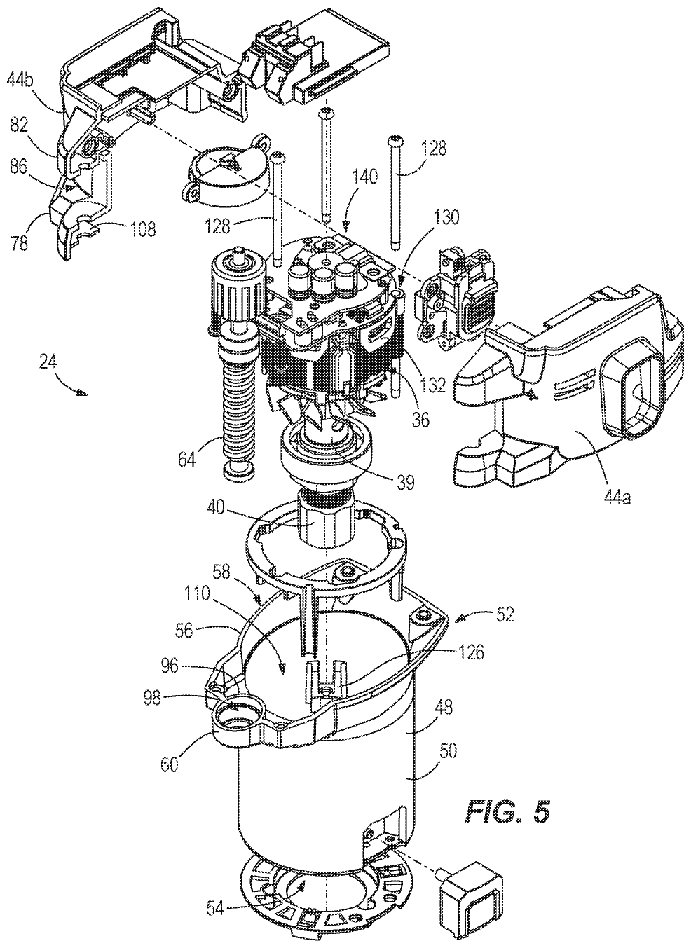

With reference to FIGS. 4-6, the depth adjustment shaft 64 is generally vertically oriented and extends through the vertically oriented first and second shaft apertures 62, 80 in the lower and upper housing portions, 48, 44, respectively. Portions of the depth adjustment shaft 64 extend above and below the top and bottom surfaces of the first and second shaft mount portions 60, 78, respectively. The depth adjustment shaft 64 is generally vertically fixed against translation relative to the upper and lower housing portions 44, 48, but is rotatable relative to the upper and lower housing portions 44, 48. The depth adjustment shaft 64 includes a threaded portion 92, and a depth adjustment knob 94 is attached to the depth adjustment shaft 64 between the threaded portion 92 and the upper end portion 90. The depth adjustment knob 94 is also part of the depth adjustment mechanism 66. In the illustrated embodiment, the depth adjustment knob 94 is received within the gap 86 between the second and third shaft mount portions 78, 82. As the depth adjustment knob 94 is rotated, depth adjustment shaft 64 including with the threaded portion 92 rotates together with the adjustment knob 94.

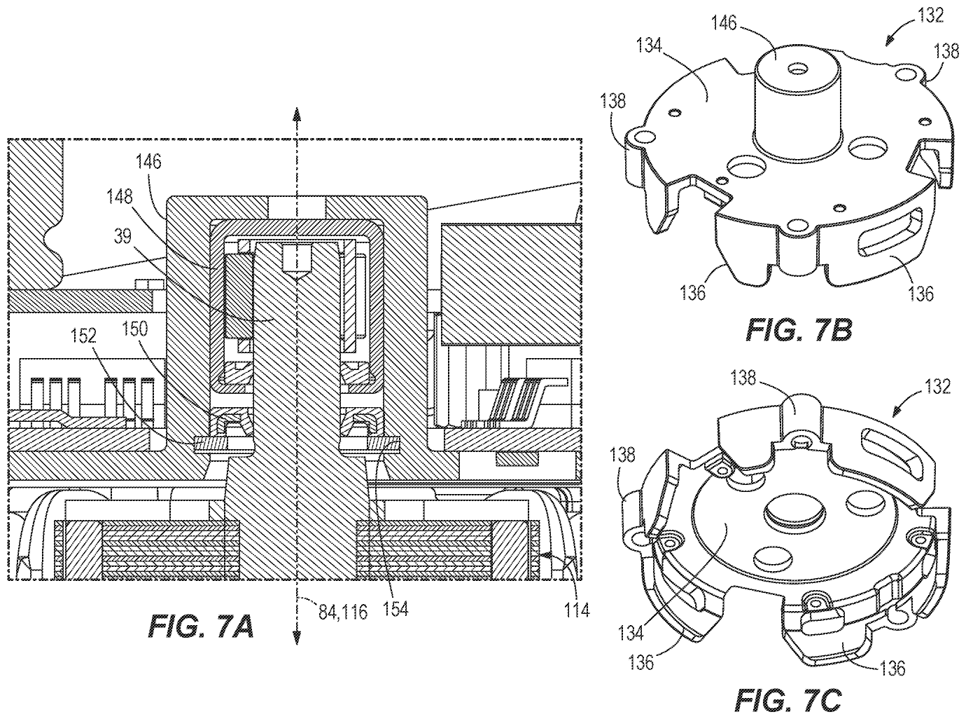

With reference to FIG. 6, the first shaft mount portion 60 of the lower housing portion 48 further includes a bushing mount 96 that defines a cylindrical recess 98 located adjacent the first shaft aperture 62. The bushing mount 96 receives a bushing 100 into the recess 98 (e.g., by press-fit engagement or interference fit), which rotatably supports the depth adjustment shaft 64 and at least partially constrains vertical movement thereof. Specifically, the depth adjustment shaft 64 passes through an inside diameter of the bushing 100 and includes an annular rib or flange 102 located between the threaded portion 92 and the depth adjustment knob 94. The flange 102 includes a lower shoulder or first shoulder 104 that abuts an end face of the bushing 100. The flange 102 also includes an upper shoulder or second shoulder 106 that abuts an end wall 108 of the second shaft mount portion 78. Thus, the first and second shoulders 104, 106 are vertically constrained between the bushing 100 and the end wall 108, respectively. The bushing 100 reduces friction, slop, and risk of binding between the lower housing portion 48 and the depth adjustment shaft 64.

With reference to FIGS. 4, 5, and 7A, the lower housing portion 48 defines an internal cavity 110 located primarily within the cylindrical outer wall 50. The motor 36 includes a generally cylindrical stator 112 and a rotor 114 surrounded by the stator 112. The rotor 114 is affixed to the output shaft 39 and co-rotates with the output shaft 39 about a motor axis 116. In the illustrated embodiment, the motor axis 116 is coaxial with the longitudinal axis 84. The stator 112 is fixedly coupled to the lower housing portion 48 and located entirely within the internal cavity 110. Stated differently, no portion of the stator 112 protrudes beyond the rim 56 of the lower housing portion 48 along a direction of the longitudinal axis 84.

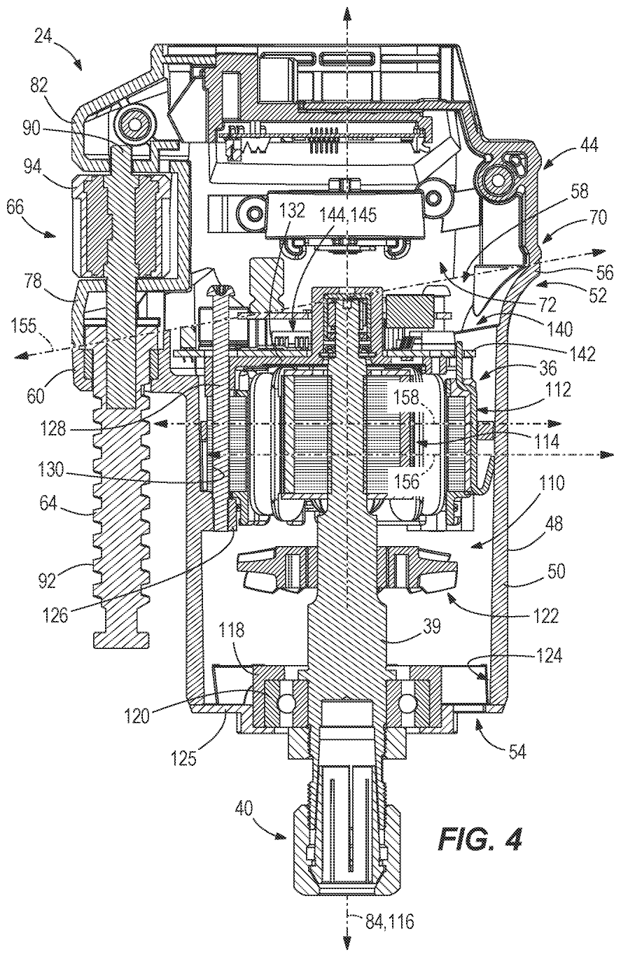

With reference to FIG. 4, the partially closed end 54 of the lower housing portion 48 defines a lower bearing pocket or first bearing mount 118. The first bearing mount 118 receives a lower bearing or first bearing 120 (e.g., by press-fit engagement or interference fit). The first bearing 120 rotatably supports the output shaft 39 and constrains vertical movement thereof. A fan 122 is fixedly coupled to the output shaft 39 and positioned between the rotor 114 and the first bearing 120 in the vertical direction. The partially closed end 54 defines a plurality of airflow apertures 124, and rotation of the fan 122 during operation of the router 20 directs an airflow from the internal cavity 110 past the first bearing 120 and outward through the airflow apertures 124. The motor unit 24 further includes a cover 125 coupled to the partially closed end 54 of the lower housing portion 48. The cover 125 supports one or more lighting devices 125A (FIG. 3) that are operable to illuminate the work surface during operation of the router 20.

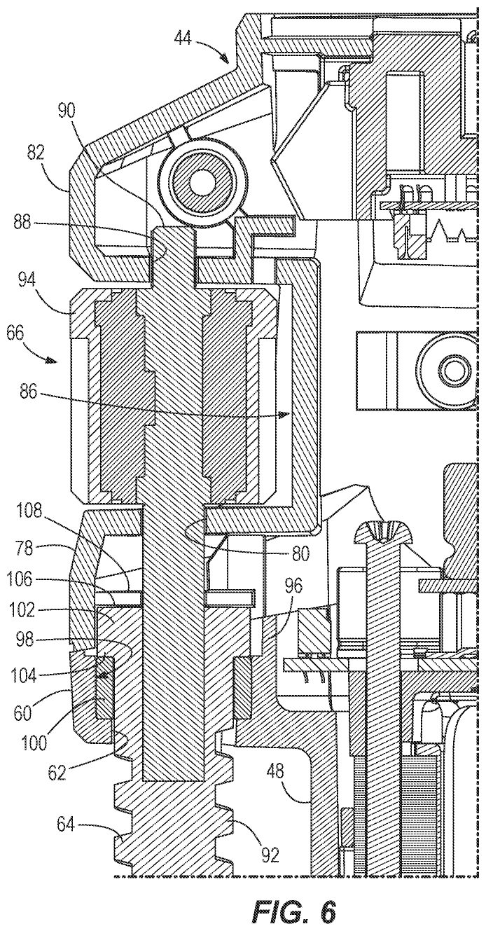

With reference to FIGS. 4 and 5, the lower housing portion 48 also includes a plurality of motor mount screw bosses 126 that protrude radially inwardly into the internal cavity 110 from an interior surface of the cylindrical outer wall 50. A plurality of screws 128 tighten into the screw bosses 126 to secure the stator 112 to the lower housing portion 48 within the internal cavity 110. In the illustrated embodiment, three screw bosses 126 protrude from the cylindrical outer wall 50 and receive three screws 128 to fixedly secure the stator 112. The stator 112 abuts the screw bosses 126 at one axial end and includes three corresponding screw apertures 130 that align with each respective screw boss 126.

With reference to FIGS. 4, 5, and 7A-7C, the motor unit 24 further includes an annular mount plate 132 fixedly coupled to the other axial end of the stator 112. The mount plate 132 includes a base wall 134 having a generally annular periphery, and a plurality of heat dissipating fins 136 located at the periphery and protruding away from the base wall 134 in an axial direction. Three mount plate screw bosses 138 are also formed at the outer periphery of the base wall 134 and located adjacent the fins 136. The screw bosses 138 align with the screw apertures 130 of the stator 112. The screws 128 insert through the screw bosses 138 of the mount plate 132, through the screw apertures 130 of the stator 112, and tighten into the screw bosses 126 of the lower housing portion 48. Accordingly, the mount plate 132 is secured to the stator 112 and the stator 112 is secured to the lower housing portion 48.

With continued reference to FIGS. 4, 5, and 7A-7C, a printed circuit board (PCB) assembly 140 is coupled to the mount plate 132. The PCB assembly 140 includes a first PCB 142 positioned directly against the base wall 134. The first PCB 142 supports a plurality of heat-generating electrical components 144 including, e.g., power switches, capacitors, processors, and the like. Heat generated by the electrical components 144 is dissipated by the mount plate 132. As such, the mount plate 132 functions as a heat sink for the PCB assembly 140. The PCB assembly 140 further includes the controller 145 configured to control operation of the motor unit 24.

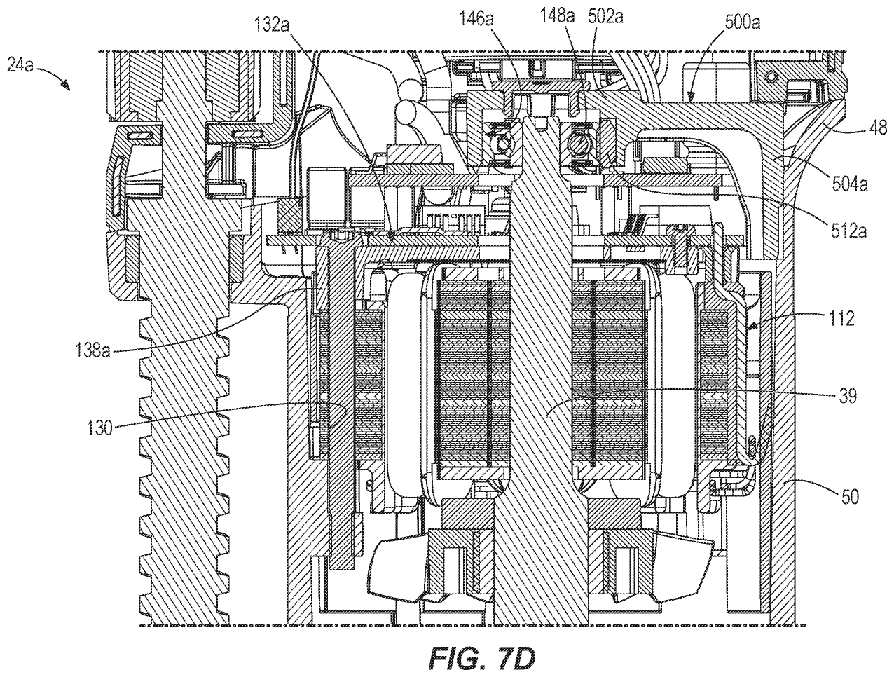

With reference to FIGS. 4 and 7A, the mount plate 132 also includes an integrally formed upper bearing pocket or second bearing mount 146 located in a central region of the base wall 134. The second bearing mount 146 is cylindrical and closed at one end and opens towards the rotor 114. The second bearing mount 146 receives and supports an upper bearing or second bearing 148, which rotatably supports the output shaft 39 at an upper end thereof. In the illustrated embodiment, the second bearing 148 is an unsealed needle bearing. To prevent ingress of debris into the second bearing mount 146, the motor unit 24 includes a seal 150 that is received into the second bearing mount 146 and located between the second bearing 148 and an opening of the second bearing mount 146. The seal 150 is ring-shaped and includes a central aperture that receives the output shaft 39 and an annular outer wall that contacts an inner surface of the bearing mount 146. The seal 150 may be formed of a pliable material, such as an elastomer (e.g., rubber). The seal 150 may further include a multi-part construction including an inner ring formed from a relatively rigid material (e.g., metal) which is surrounded by an outer cover formed from the pliable material. The seal 150 is retained in the second bearing mount 146 by a snap member 152 (e.g., a circlip) that is removably received into a circumferential internal groove 154 formed in a sidewall of the second bearing mount 146 adjacent the opening thereof.

FIGS. 7D-7F illustrate portions of a modified motor unit 24a according to another embodiment of the disclosure. The modified motor unit 24a is identical or similar to the motor unit 24 in many respects, and as such, the following description will focus on only those aspects of the motor unit 24a that differ from the motor unit 24. Features and elements of the motor unit 24a that are not expressly described herein are the same as the features and elements of the motor unit 24.

The motor unit 24a includes a modified mount plate 132a fixedly coupled to an axial end of the stator 112. The mount plate 132a includes screw bosses 138a formed in its outer periphery and aligned with screw apertures 130 of the stator 112. Unlike the mount plate 132 described above, however, the mount plate 132a does not include a bearing mount. Instead, the motor unit 24a includes a bearing support member 500a that is formed separately from the mount plate 132a and that forms a second bearing pocket or second bearing mount 146a. The bearing support member 500a includes a central hub 502a and a plurality of L-shaped legs 504a (three in the illustrated embodiment) protruding radially and axially away from the central hub 502a. The bearing support member 500a couples directly to the lower housing portion (e.g., by interference fit with the legs 504a engaging an interior surface of the cylindrical outer wall 50 of the lower housing portion 48).

With reference to FIGS. 7E and 7F, the central hub 502a of the bearing support member 500a defines the second bearing mount 146a, which receives and supports an upper bearing or second bearing 148a. The second bearing 148a rotatably supports the output shaft 39 at an upper end thereof for rotation about the motor axis 116. To prevent ingress of debris into the second bearing mount 146a, the motor unit 24a includes a seal 150a that is received into an upper opening 506a of the second bearing mount 146a.

With reference to FIG. 7F, the central hub 502a includes an annular wall 508a that defines the second bearing mount 146a. A plurality of recesses or damper pockets 510a are formed in the annular wall 508a (three in the illustrated embodiment). The damper pockets 510a are partially cylindrical in the illustrated embodiment and open or face toward an interior of the second bearing mount 146a. The motor unit 24a further includes a plurality of vibration damping elements 512a (three in the illustrated embodiment) that are received into the damper pockets 510a. The damping elements 512a are generally cylindrical in shape and formed of an elastic material (e.g., an elastomer). When the second bearing 148a is received into the second bearing mount 146a, an outer race of the second bearing 148a contacts a portion of each damping element 512a and an inner race of the second bearing 148a contacts the output shaft 39. The damping elements 512a are interposed between the outer race of the second bearing 148a and the annular wall 508a of the bearing support member 500a and function to dampen transmission of vibrations between the output shaft 39 and the bearing support member 500a.

Referring again to FIG. 4 and the motor unit 24, the cylindrical outer wall 50 of the lower housing portion 48 defines a width or diameter 156. In the illustrated embodiment, the diameter 156 is approximately 82 millimeters (mm). In other embodiments, the diameter 156 may be less than or equal to 82 mm. In addition, a width or outside diameter 158 of the stator 112, measured along a direction transverse to the motor axis 116 at a widest portion of the stator 112, is approximately 60 mm. In other embodiments, the outside diameter 158 may be less than or equal to 60 mm.

With continued reference to FIG. 4, the rim 56 of the lower housing portion 48 defines a straight reference plane 155. The plane 155 coincides with the opening 58. As shown in FIG. 4, the motor 36 is contained completely within the internal cavity 110. Stated differently, the motor 36 is located below the plane 155. As such, the stator 112 and the rotor 114 are each located below the plane 155 and within the internal cavity 110.

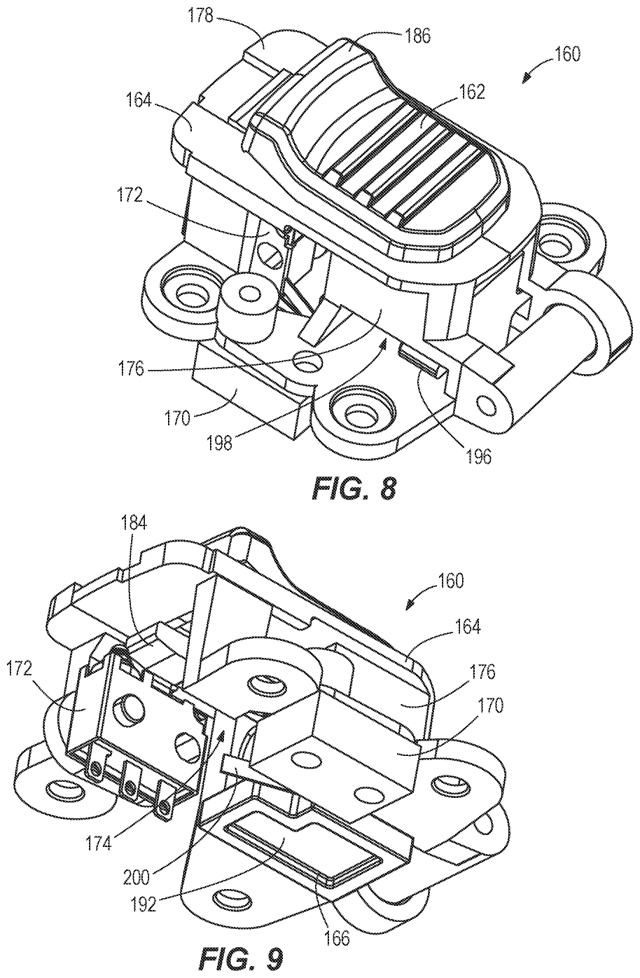

With reference to FIGS. 2 and 8-15, the upper housing portion 44 also supports a switch assembly 160. In the illustrated embodiment, the switch assembly 160 is a two-action switch assembly 160 that is operable to perform two different switching functions. The two-action switch assembly 160 includes an actuator 162 that moves in two degrees of freedom to perform the two different switching functions. The switch assembly 160 also includes a switch housing 164, a slider 166, a biasing member 168, a first switch 170, and a second switch 172.

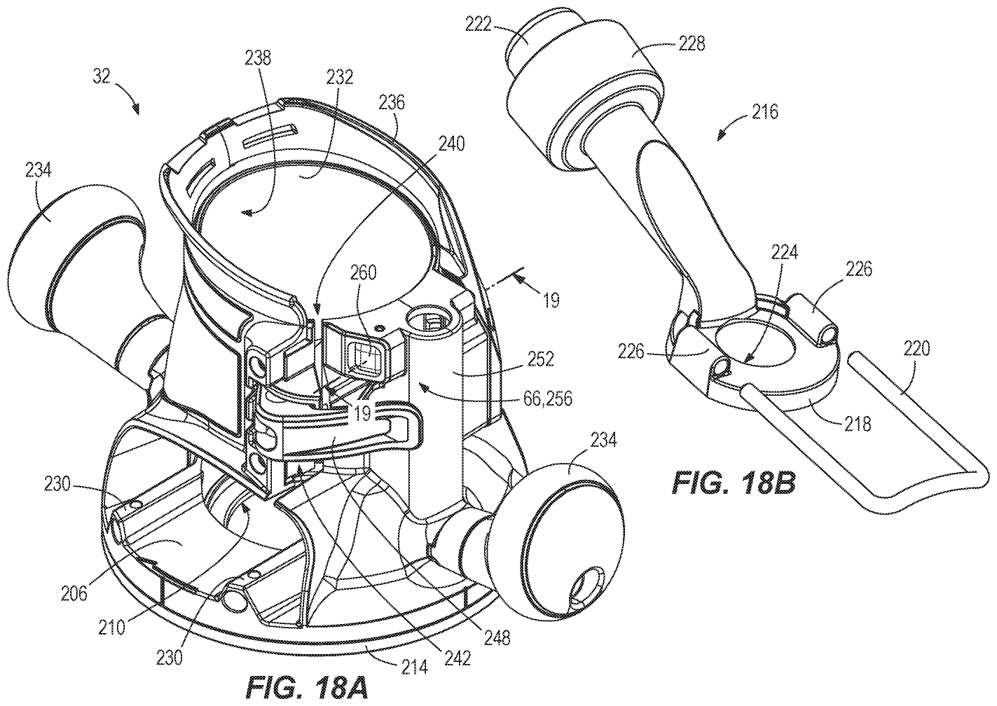

The switch housing 164 movably supports the actuator 162, the slider 166, the biasing member 168, and the first and second switches 170, 172. The switch housing 164 defines a cavity 174 and includes sidewalls 176 and a top wall 178 having a slot 180 through which a portion of the actuator 162 extends into the cavity 174. The actuator 162 includes a button portion 182 positioned adjacent the top wall 178 and an L-shaped arm 184 extending away from the button portion 182 and into the cavity 174. At one longitudinal end of the button portion 182, a raised portion 186 protrudes from one side thereof and a catch 188 protrudes from the other side. The catch 188 selectively engages a ledge 190 defined by the top wall 178 as will be discussed below. The actuator also includes a protruded ridge 191 (FIG. 14) that contacts the surface of the top wall 178. The protruded ridge 191 reduces a surface area of the button portion 182 that is in contact with the top wall 178, thereby reducing friction during sliding operation, and further functions as a fulcrum during operation of the actuator 162 as will be further described.

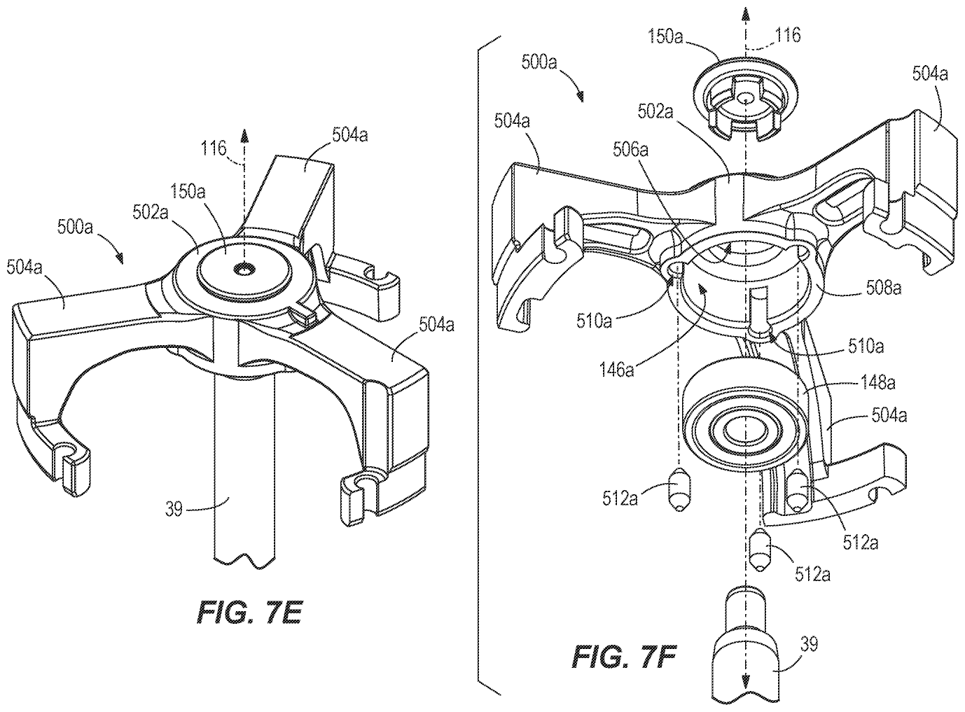

The slider 166 includes a protruding actuation portion 192 located adjacent the first switch 170 and a hook portion 194 that engages the arm 184 of the actuator 162. The slider 166 also includes a pair of protruding tabs 196 (FIG. 8) that reside within corresponding channels 198 defined in the sidewalls 176 of the switch housing 164 to guide the translational motion of the slider 166. The biasing member 168 is embodied, in the illustrated embodiment, as a coil spring that acts upon the hook portion 194 of the slider 166. The first switch 170 is affixed to the switch housing 164 adjacent the actuation portion 192 of the slider 166. The second switch 172 is affixed to the switch housing 164 adjacent the arm 184 of the actuator 162.

In the illustrated embodiment, the first switch 170 is formed as a microswitch having an actuation arm 200 that is movable to open or close the first switch 170. The first switch 170 is electrically connected to the lighting devices 125a. When the first switch 170 is closed, the lighting devices 125a are activated to illuminate a workpiece as will be further described herein. In other embodiments (not shown), the first switch 170 can alternatively be formed as a Hall effect sensor operable to send an activation signal to the controller 145 (FIG. 4) to activate the lighting devices 125a. In the illustrated embodiment, the second switch 172 is also formed as a microswitch having a plunger 202 that is movable to open or close the second switch. The second switch 172 is electrically connected to the controller 145. The controller 145 activates the motor 36 in response to the second switch 172 being closed.

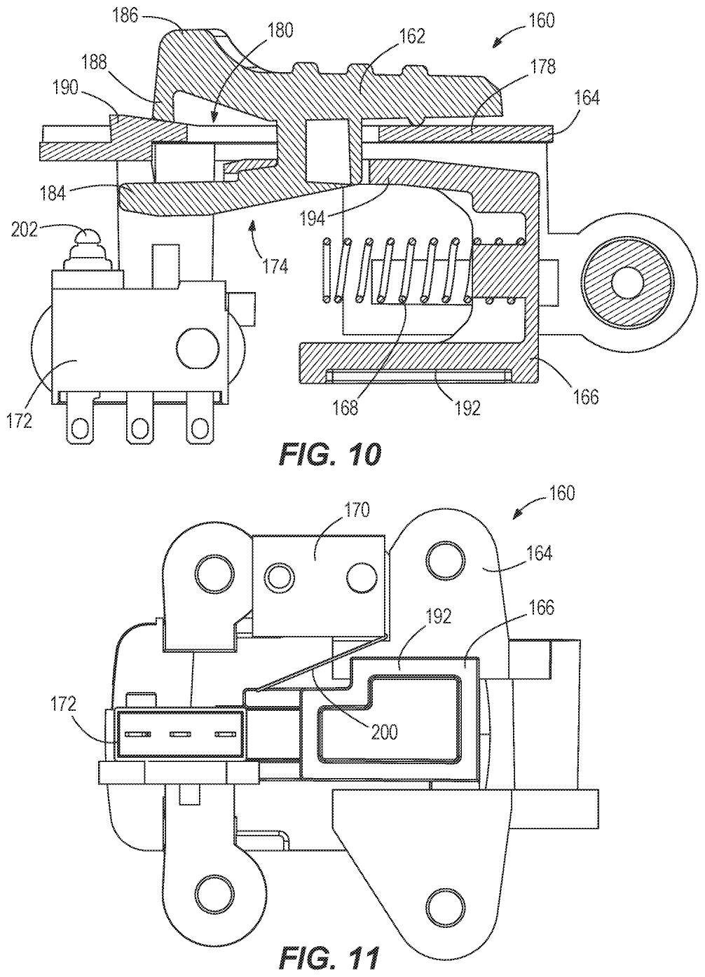

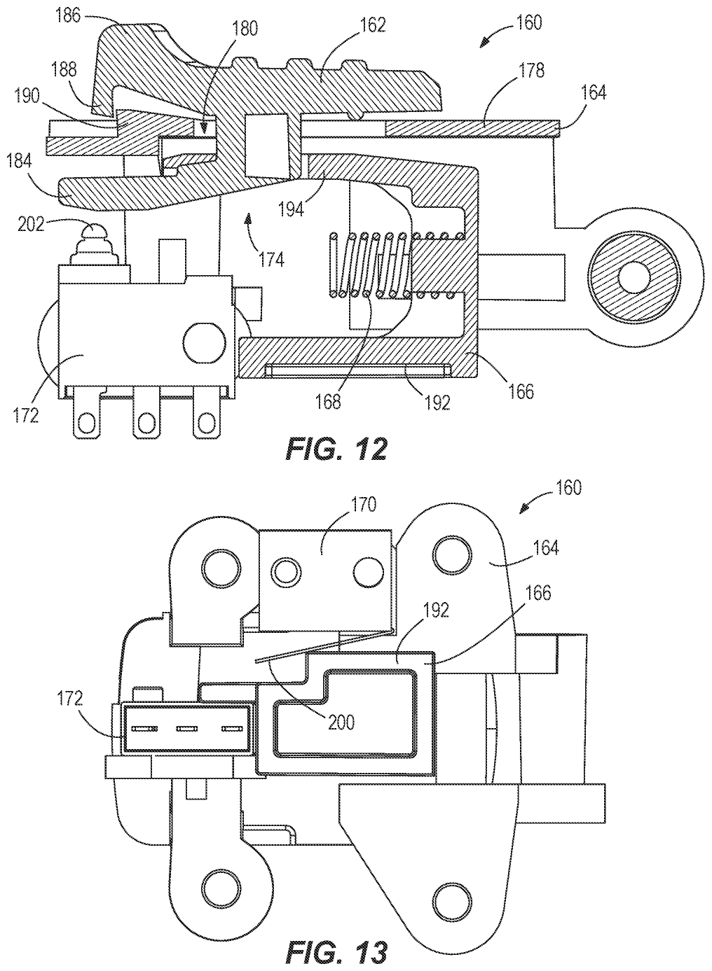

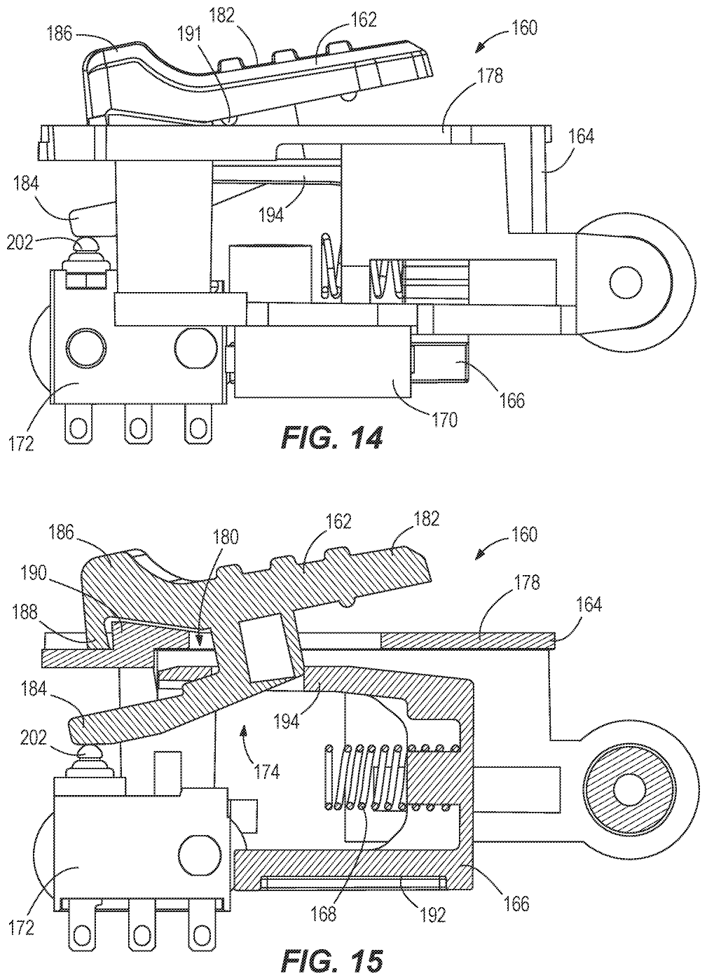

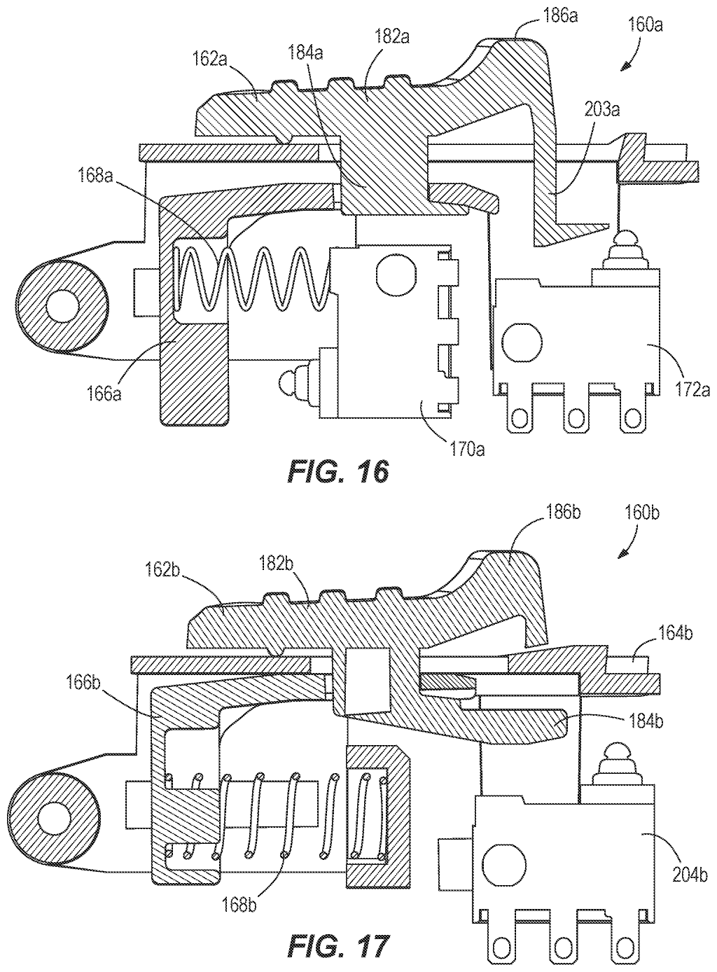

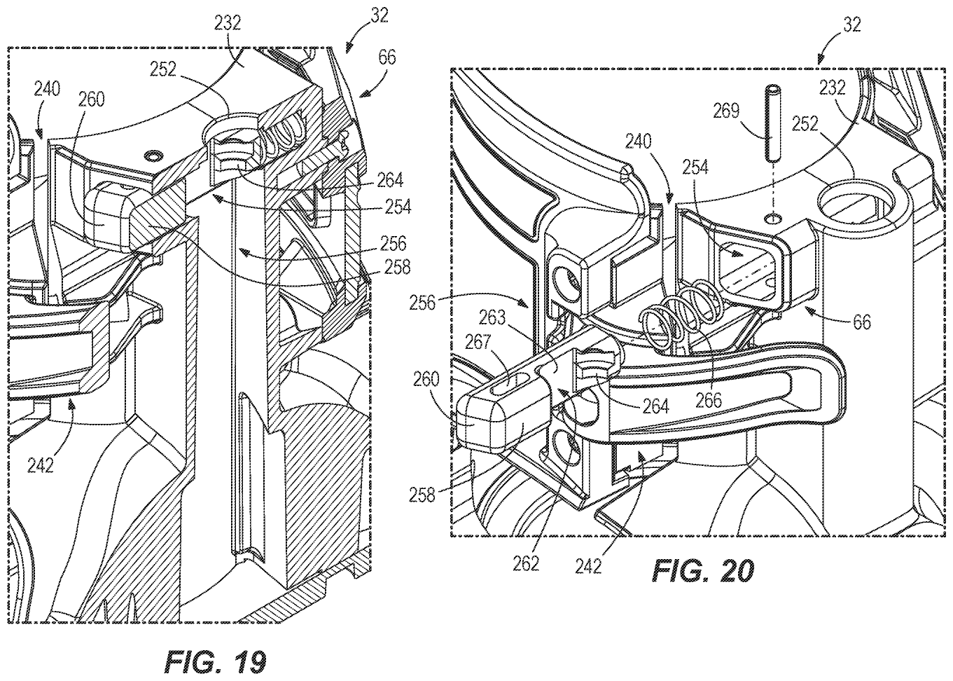

The actuator 162 is movable between three different positions including an off position (FIGS. 10 and 11), a first actuated position (FIGS. 12 and 13), and a second actuated position (FIGS. 14 and 15). From the off position, the actuator 162 translates or slides forwardly to the first actuated position (i.e., a first switching action). The arm 184 engages the hook portion 194 to move the slider 166 with the actuator 162 from the off position to the first actuated position, against the biasing force of the biasing member 168. In the first actuated position, the actuation portion 192 engages the arm 200 of the first switch 170 to close the first switch 170, causing the lighting devices 125a to activate. From the first actuated position, the raised portion 186 of the actuator 162 can then be pressed downwardly (i.e., toward the upper housing portion 44) to pivot the actuator 162 to the second actuated position (i.e., a second switching action). Pivoting the actuator 162 to the second actuated position causes the catch 188 to engage the ledge 190 of the top wall 178, which holds the actuator 162 in the second actuated position against the bias of the biasing member 168. The actuator 162 pivots about the protruded ridge 191 (FIG. 14), which acts as a fulcrum against the top wall 178 of the switch housing 164. In the second actuated position, the arm 184 engages the plunger 202 of the second switch 172, causing the motor 36 to activate. The slider 166 remains engaged with the first switch 170 in the second actuated position such that the lighting devices 125a remain activated.

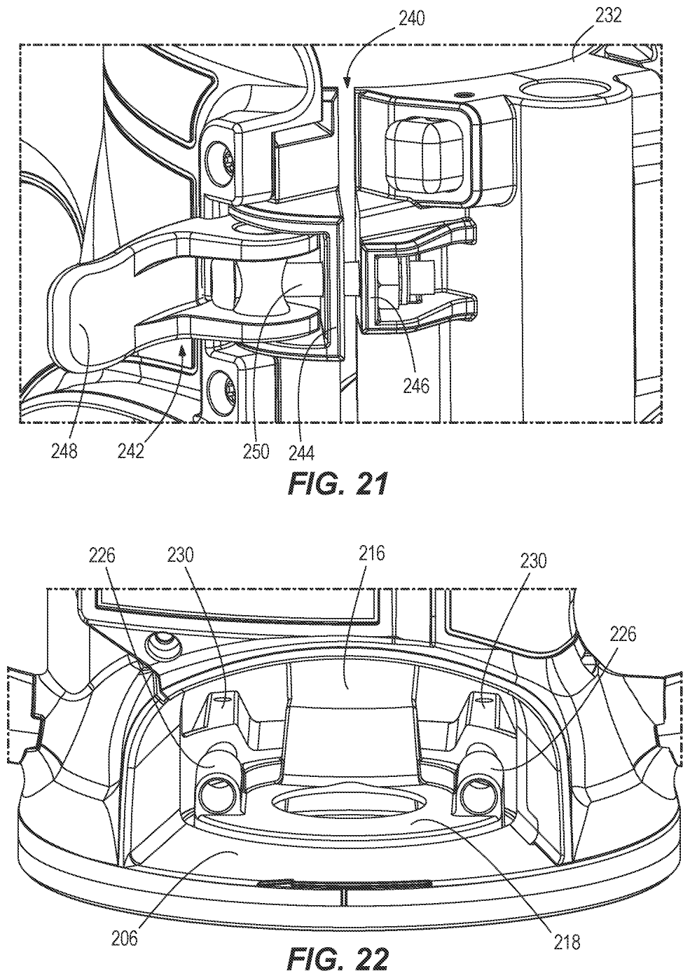

FIG. 16 illustrates a two-action switch assembly 160a according to another embodiment of the disclosure. The switch assembly 160a is similar to the switch assembly 160 described above, and the following disclosure will focus primarily on the differences between the switch assemblies 160 and 160a. The switch assembly 160a includes an actuator 162a, a slider 166a, a biasing member 168a, a first switch 170a electrically connected to the lighting devices 125a, and a second switch 172a electrically connected to the controller 145 (FIG. 4) and operable to activate the motor 36. The components of the switch assembly 160a, including the actuator 162a, the slider 166a, the biasing member 168a, the first switch 170a, and the second switch 172a, are supported directly in by the upper housing portion 44 in the illustrated embodiment. In other embodiments (not shown), the components of the switch assembly 160a can instead by supported by a separate switch housing similar to the switch housing 164 described above.

The actuator 162a includes a button portion 182a having a protruding raised portion 186a, and an L-shaped arm 184a extending away from the button portion 182a to engage the slider 166a. The arm 184a, however, does not actuate the second switch 172a. Instead, the actuator 162a further includes an additional arm 203a protruding away from the button portion 182a opposite the raised portion 186a and located adjacent the second switch 172a. The additional arm 203a is configured to actuate the second switch 172a. In operation, when the actuator 162a translates or slides from the off position to the first actuated position (i.e., a first switching action), the arm 184a moves the slider 166a into engagement with the first switch 170a, causing the lighting devices 125a to activate. When the actuator 162a is rotated from the first actuated position to the second actuated position (i.e., a second switching action), the arm 203a engages the second switch 172a, causing the motor 36 to activate.

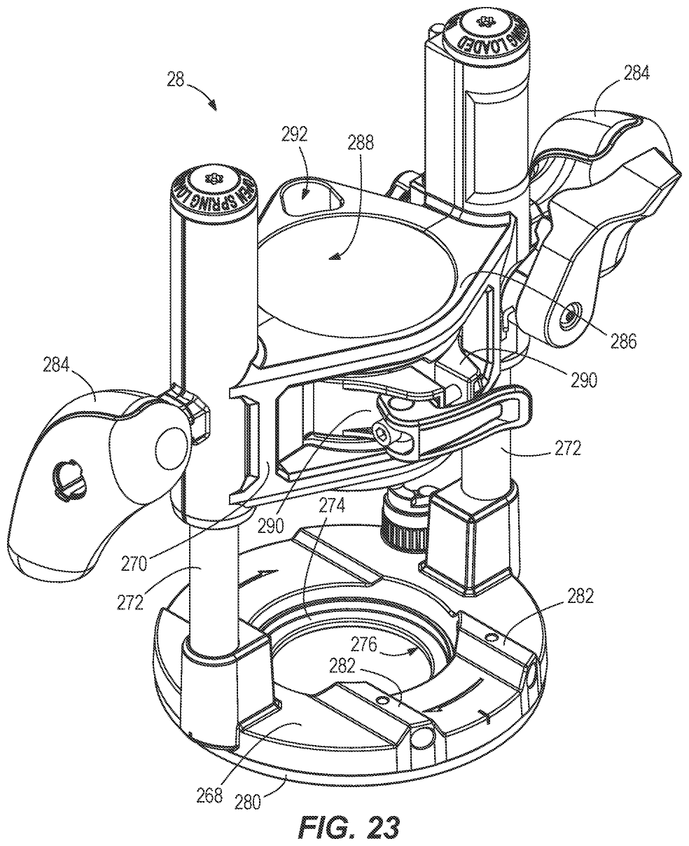

FIG. 17 illustrates a two-action switch assembly 160b according to another embodiment of the disclosure. The switch assembly 160b is similar to the switch assembly 160 described above, and the following disclosure will focus primarily on the differences between the switch assemblies 160 and 160b. The switch assembly 160b includes an actuator 162b, a slider 166b, a biasing member 168b, and a single switch 204b operable to cause both the lighting devices 125a and the motor 36 to activate. The slider 166b acted upon by the biasing member 168b in a manner similar to the slider 166 and biasing member 168 described above. The slider 166b, however, does not include an actuation portion and does not actuate a switch. The actuator 162b includes a button portion 182b having a protruding raised portion 186b, and an L-shaped arm 184b extending away from the button portion 182b to engage the slider 166b. The arm 184b is located adjacent the switch 204b. In operation, when the actuator 162b translates or slides from the off position to the first actuated position (i.e., a first switching action), the arm 184b moves the slider 166b against the bias of the biasing member 168b, but no switch is actuated. When the actuator 162b is rotated from the first actuated position to the second actuated position (i.e., a second switching action), the arm 184b engages the switch 204b, causing both the lighting devices 125a and the motor 36 to activate.

### The Fixed Base

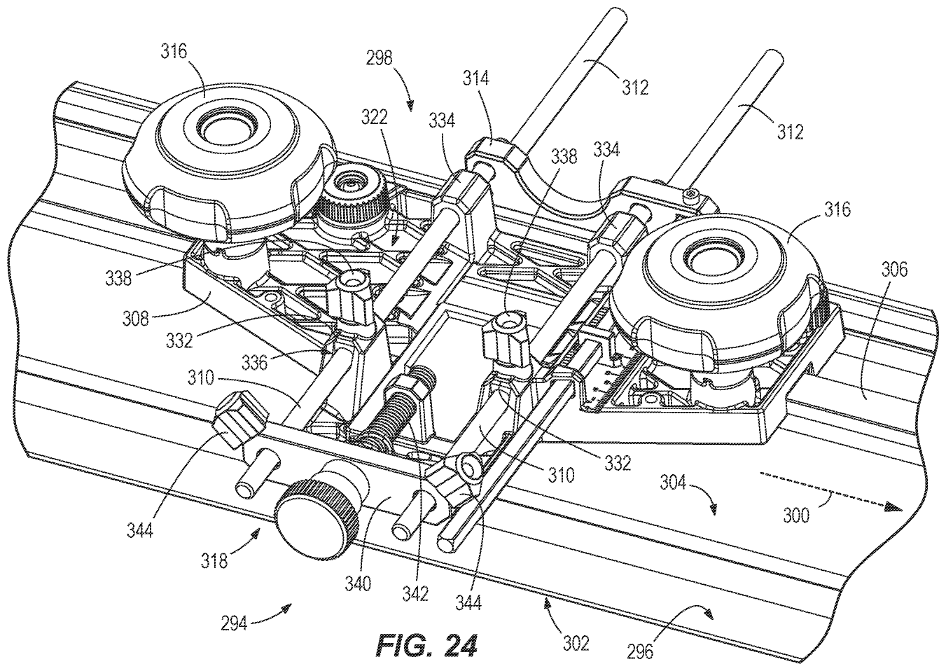

As shown in FIG. 18A, the fixed base 32 includes an annular lower base portion 206 having an aperture 210 defined therein. The aperture 210 is configured to allow the tool element to pass through the lower base portion 206 and contact a workpiece. A bottom surface of the lower base portion 206 is engageable with a work surface, such as the surface of a workpiece. In the illustrated embodiment, the lower base portion 206 is coupled to a sub-base or base plate 214 designed to interface with a work surface, such as the surface of the workpiece. In some embodiments, additional components can be coupled to the lower base portion 206 or the base plate 214 to help keep at least some dust and other debris in generally confined areas.

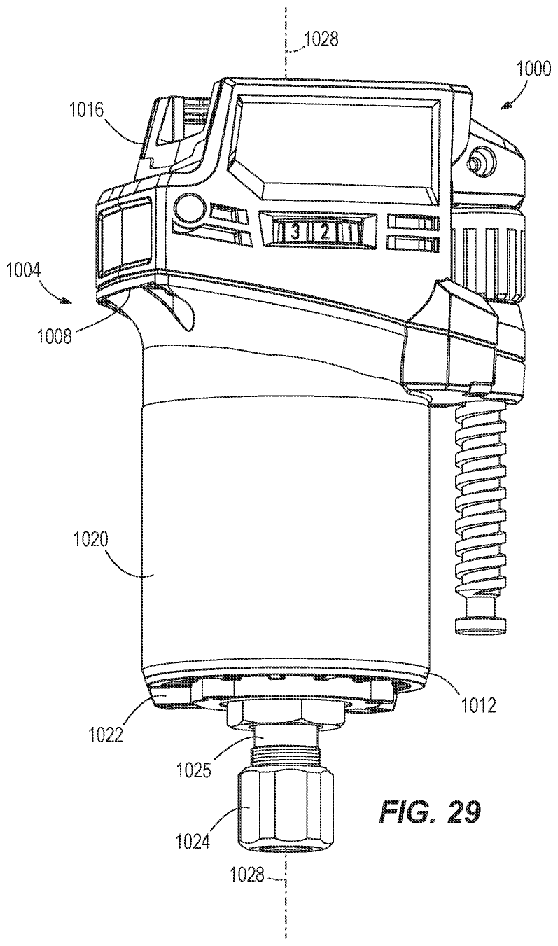

With reference to FIGS. 18B and 22, a dust chute 216 couples to the lower base portion 206 to remove dust and other debris from the cutting area during operation. The dust chute 216 includes a body 218, a fastener or connection rod 220, and an exhaust port 222 extending from the body 218. A central aperture 224 is defined in the body 218 to allow the tool element to pass through the dust chute 216 during router operation without interference. The body 218 also includes a pair of channels or connectors 226 extending vertically upward from the body 218 and being operable to removably receive respective ends of the connection rod 220. In the illustrated embodiment, the connection rod 220 is U-shaped and includes two ends, one end removably positionable in each of the connectors 226. The exhaust port 222 includes a coupling 228 at an end distal from the body 218. A hose, tubing, or other device is coupled to the coupling 228 at one end and coupled to a vacuum source at the other end thereof to facilitate removal of debris from the work area.

With continued reference to 18B and 22, connection of the dust chute 216 to the router 20 will be described. The lower base portion 206 of the fixed base 32 includes a pair of channels or connectors 230 for typically receiving and supporting fasteners or connection rods of an edge guide (not shown). The dust chute 216 is connected to the lower base portion 206 using the same connectors 230 used to connect the edge guide to the router fixed base 32. The connection rod 220 is removed from the connectors 226 and the body 218 of the dust chute 216 is positioned within the aperture 210 of the lower base portion 206 (as shown in FIG. 22) such that the connectors 226 align with the connectors 230 of the lower base portion 206. The ends of the connection rod 220 are then inserted into and through respective connectors 230, and into and through respective connectors 226 of the dust chute 216. With the connection rod 220 in place, the dust chute 216 is connected to the lower base portion 206 of the fixed base 32. The dust chute 216 is removable by reversing the connection steps described above.

With reference to FIGS. 18A and 19-21, the fixed base 32 also includes a generally cylindrical annular sleeve 232 extending upwardly from the lower base portion 206. The sleeve 232 may be fastened to, or formed integrally with, the lower base portion 206.

A pair of knob-like handles 234 are removably mountable on the fixed base 32 on opposite sides of the sleeve 232. The handles 234 preferably include soft-grip material covering at least a portion thereof to provide extra friction for gripping. As shown in FIG. 18A, the router 20 also includes a hand grip 236 attachable to the fixed base 32 of the router 20. The hand grip 236 is attachable to an outer surface of the sleeve 232 by fasteners.

With continued reference to FIGS. 18A and 19-21, the sleeve 232 of the fixed base 32 also has an inner surface 238 which may be slightly tapered outward in an upward direction. The sleeve 232 is somewhat resilient and is open on one side at a vertical seam 240. As a result, the inner diameter of the sleeve 232 may be increased or decreased by opening or closing, respectively, the seam 240. The resilience of the sleeve 232 results in the seam 240 being partially open when no force is applied to close the seam 240.

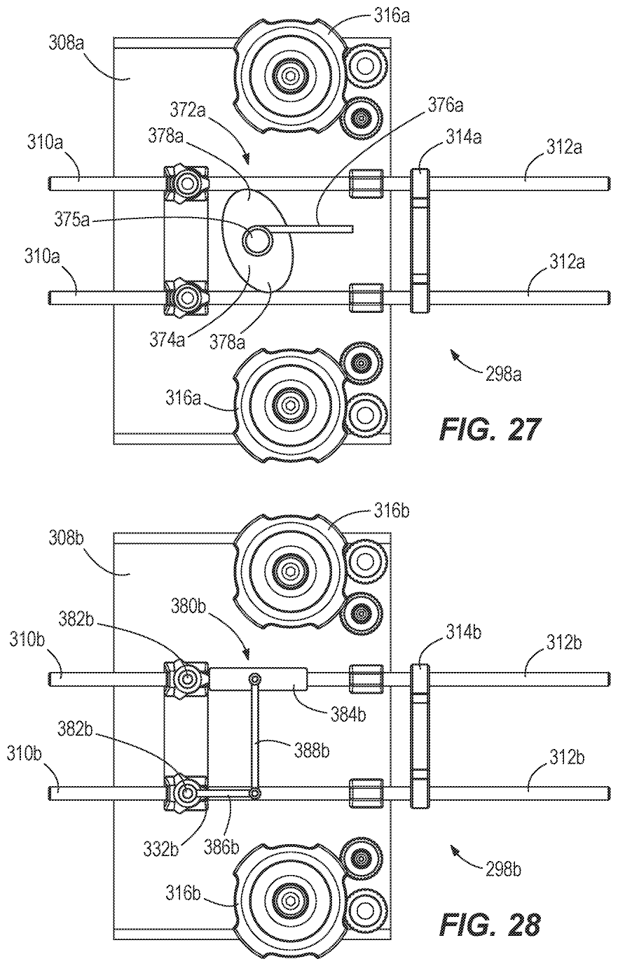

As shown in FIGS. 18A and 21, the fixed base 32 includes a clamp mechanism 242 to control the opening and closing of the seam 240. When the seam 240 is generally closed, the fixed base 32 is in a clamped position, in which the position of the motor unit 24 relative to the fixed base 32 is fixed. When the seam 240 is open, the fixed base 32 is in a released position, in which the motor unit 24 is movable relative to the fixed base 32. The clamp mechanism 242 includes a clamp pocket or clamp flange 244 formed on the sleeve 232 on one side of the seam 240. The clamp flange 244 has an aperture therethrough. The clamp mechanism 242 also includes a clamp-receiving block 246 formed on the sleeve 232 on the other side of the seam 240. The clamp-receiving block 246 includes an aperture (not shown) corresponding to the aperture in the clamp flange 244.

With continued reference to FIGS. 18A and 21, the clamp mechanism 242 also includes an actuator or clamp handle 248 and a clamping pin 250 coupled to a cam portion of the clamp handle 248. The clamping pin 250 extends through the clamp flange 244 and into the clamp-receiving block 246. The clamping pin 250 is anchored within the clamp-receiving block 246. The clamp handle 248 can rotate relative to the clamping pin 250, which causes the cam portion of the clamp handle 248 to interact with the clamp flange 244 to open or close the seam 240.

When the clamp handle 248 is pivoted generally away from the seam 240, the seam 240 is open. When the seam 240 is open, the clamping force applied by the fixed base 32 to the motor unit 24 is reduced so that the motor unit 24 is movable relative to the fixed base 32. To close the seam 240, the clamp handle 248 is rotated generally toward the seam 240. As the handle 248 is rotated, the clamp flange 244 is forced closer to the clamp-receiving block 246 to close the seam 240. When the seam 240 is closed, the clamping force is increased to fix the motor unit 24 in a position relative to the fixed base 32.

As shown in FIGS. 2 and 18A, the lower housing portion 48 of the motor unit 24 is generally vertically oriented and has a generally cylindrical outer surface. The lower housing portion 48 can be received within the sleeve 232 of the fixed base 32 and be vertically movable relative to the sleeve 232. Closing the seam 240 using the clamp mechanism 242, as described above, causes the inner surface 238 of the sleeve 232 to engage the outer surface of the lower housing portion 48 and to restrict the vertical movement of the motor unit 24 relative to the fixed base 32. Opening the seam 240 releases the lower housing portion 48 and allows the motor unit 24 to be moved vertically.

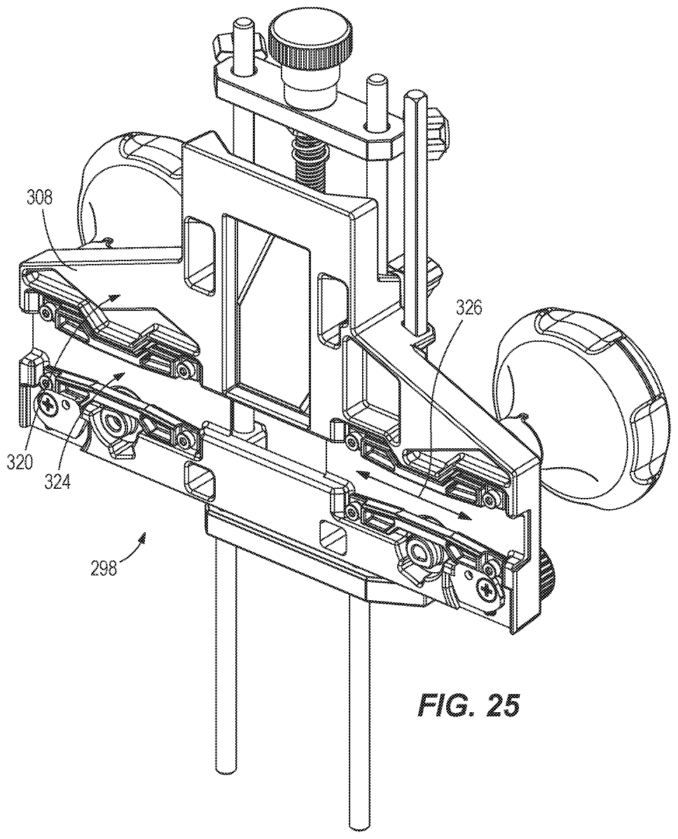

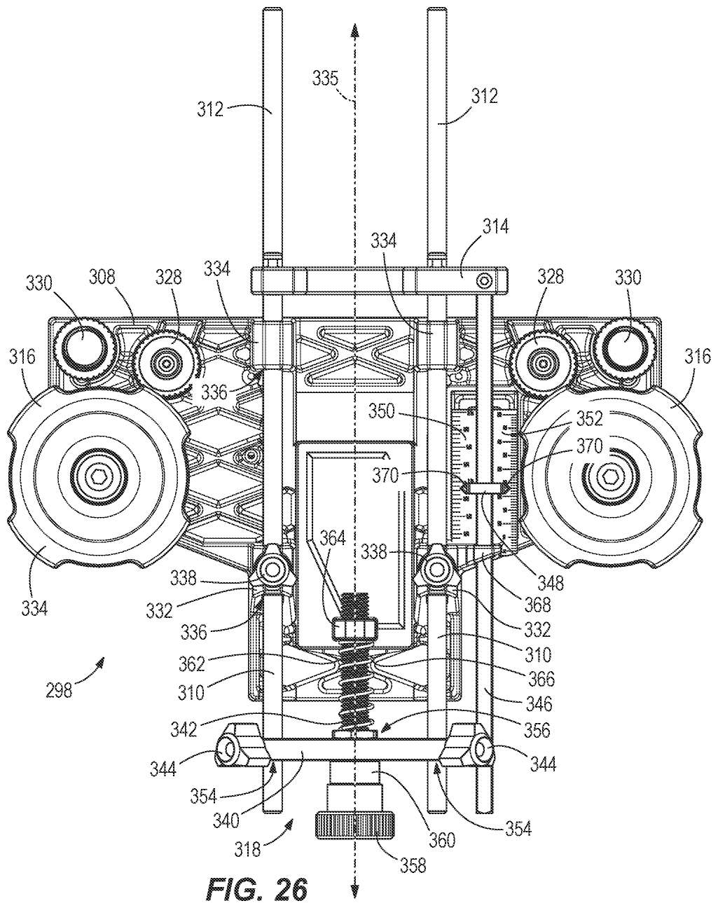

As shown in FIGS. 18A, 19, and 20, the fixed base 32 defines a depth adjustment column 252 adjacent the clamp-receiving block 246. The depth adjustment column 252 is formed integrally with the sleeve 232 in the illustrated embodiment, although the column could be formed separately in other embodiments. The depth adjustment column 252 is generally hollow and has (see FIGS. 19 and 20) an open top end.

The fixed base 32 also defines a lock mechanism receptacle 254 in the sleeve 232 proximate the open top end of the depth adjustment column 252. The lock mechanism receptacle 254 includes an open end and an aperture, and the aperture is vertically aligned with the open top end of the depth adjustment column 252.

With continued reference to FIGS. 18A, 19, and 20, the depth adjustment mechanism 66 also includes a lock mechanism 256 enclosed partially within the lock mechanism receptacle 254. The lock mechanism 256 is vertically fixed to the fixed base 32 and is movable in a direction perpendicular to the axis of the depth adjustment column 252. The lock mechanism 256 includes a lock key 258 having a lock button 260, engageable by the operator to move the lock key 258, and defining a lock key recess 262, beside which the threaded portion 92 of the depth adjustment shaft 64 passes.

The lock key recess 262 includes an inner surface 263 and at least one locking projection or thread-engaging lug 264 formed on the inner surface 263. The lug 264 is selectively engageable with the threaded portion 92 of the depth adjustment shaft 64. The lock key 258 is movable between a thread-engaging position, in which the lug 264 engages the threaded portion 92, and a disengaged position, in which the lug 264 does not engage the threaded portion 92. The lock key 258 is biased outwardly to the thread-engaging position by a spring or other biasing member 266.

The lock key 258 also defines an elongated slot 267 that receives a pin 269 affixed to the depth adjustment column 252 and extending through the receptacle 254. As the lock key 258 is actuated, the pin 269 traverses the slot 267, which limits the range of travel of the lock key 258 and retains the lock key 258 within the receptacle 254.

The depth adjustment mechanism 66 may be used to adjust the vertical position of the motor unit 24 relative to the fixed base 32 in two modes. For coarse adjustment, the lock button 260 is pushed inward against the biasing member 266, releasing the threaded portion 92 from engagement with the lug 264. The motor unit 24 with the depth adjustment shaft 64 are then free to move translatably in a vertical direction relative to the lock key 258 and the fixed base 32. Once the desired vertical position of the depth adjustment shaft 64 and the motor unit 24 is achieved, the lock button 260 is released and the biasing member 266 again biases the lock key 258 outward to the thread-engaging position and the lug 264 engages the threaded portion 92. Once the lug 264 is re-engaged with the depth adjustment shaft 64, the motor unit 24 with the depth adjustment shaft 64 are restricted from free translational movement.

For fine adjustment, the lock mechanism 256 remains engaged with the depth adjustment shaft 64. The depth adjustment knob 94 is rotated, which causes the depth adjustment shaft 64 including the threaded portion 92 to rotate therewith. The threaded portion 92 rotates relative to the lug 264 so that the motor unit 24 with the depth adjustment shaft 64 move in relatively small increments in a vertical direction relative to the lock key 258 and the fixed base 32.

In operation, an operator often needs to adjust the depth of cut of the router 20. To adjust the router 20 from a first depth of cut to second depth of cut, the operator first releases the clamp mechanism 242, as described above. This action releases the sleeve 232 from clamping engagement with the motor unit 24 and allows the motor unit 24 to be vertically moved relative to the fixed base 32. Coarse adjustment of the position of the motor unit 24 relative to the fixed base 32 is preferably performed first as described above. Fine adjustment of the position is then performed. Once the desired vertical position is achieved, the operator clamps the clamp mechanism 242, thus clampingly re-engaging the sleeve 232 with the motor unit 24 and substantially restricting the motor unit 24 from further movement relative to the fixed base 32. The operator then operates the router 20 by grasping either the two knob-like handles 234 or the hand grip 236, as desired. Additional depth adjustments may be made by repeating this process.

### The Plunge Base

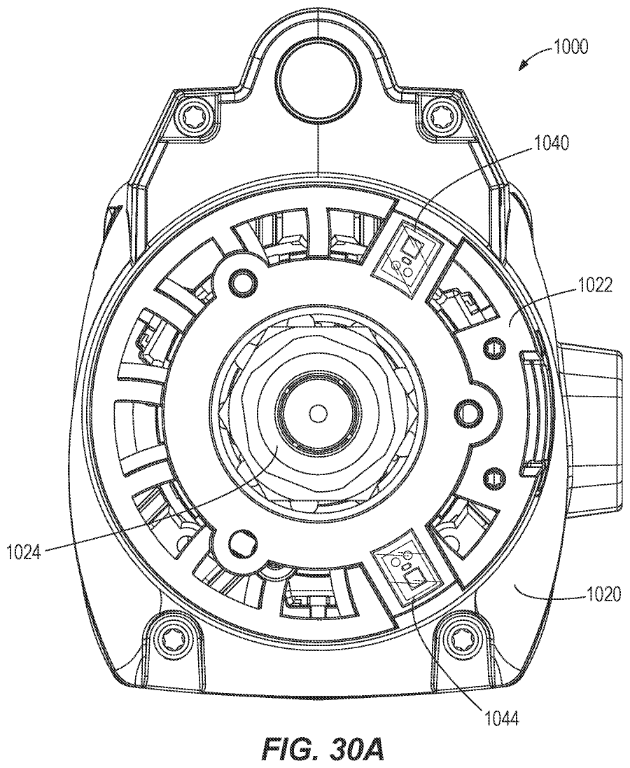

Referring now to FIGS. 1 and 23, the plunge base 28 includes a lower base portion 268 and a base support component 270. At least two guide posts 272 are coupled to the lower base portion 268 and extend substantially vertically upward from the lower base portion 268. The guide posts 272 are received in guide channels (not shown) formed in the base support component 270, and the base support component 270 is vertically movable along the guide posts 272 relative to the lower base portion 268. The base support component 270 and lower base portion 268 are biased away from each other by at least one spring element (not shown) or other biasing member positioned in at least one of the guide channels.

The lower base portion 268 includes a recess 274 and an opening 276 defined in a bottom of the recess 274 configured to allow the tool element to pass through the lower base portion 268 and contact a workpiece. A bottom surface of the lower base portion 268 is engageable with a work surface, such as the surface of the workpiece. In the illustrated embodiment, the lower base portion 268 is coupled to a sub-base or base plate 280 designed to interface with a work surface, such as the surface of a workpiece. In some embodiments, additional components can be coupled to the lower base portion 268 or the base plate 280 to help keep at least some dust and other debris in generally confined areas.

With reference to FIG. 23, the lower base portion 268 of the plunge base 28 includes a pair of channels or connectors 282 for typically receiving and supporting fasteners or connection rods of an edge guide (not shown). The dust chute 216 is connected to the lower base portion 268 using the same connectors 282 used to connect the edge guide to the router fixed base 32. The dust chute 216 couples to the lower base portion 268 in the same manner as described above with respect to the fixed base 32, to remove dust and other debris from the cutting area during operation.

The plunge base 28 also includes a pair of handles 284 coupled to opposite sides of the base support component 270. In some embodiments, a soft-grip material covers at least a portion of the handles 284.

With continued reference to FIG. 23, the base support component 270 includes a circumferential wall 286 that defines a central aperture 288 for receiving the lower housing portion 48 of the motor unit 24. A cutout defined in the circumferential wall 286 forms a pair of movable tabs 290 that are operable to clamp or release the lower housing portion 48 to secure the motor unit 24 within the base support component 270. The circumferential wall 286 also defines a depth adjustment aperture 292 that extends parallel to the central aperture 288 and is open at its top and bottom ends. The depth adjustment aperture 292 receives depth adjustment shaft 64 when the lower housing portion 48 is inserted into the central aperture 288. The motor unit 24 is fully inserted into the base support component 270 when the first shaft mount portion 60 (FIG. 2) of the lower housing portion 48 rests atop the circumferential wall 286.

### The Track Adapter

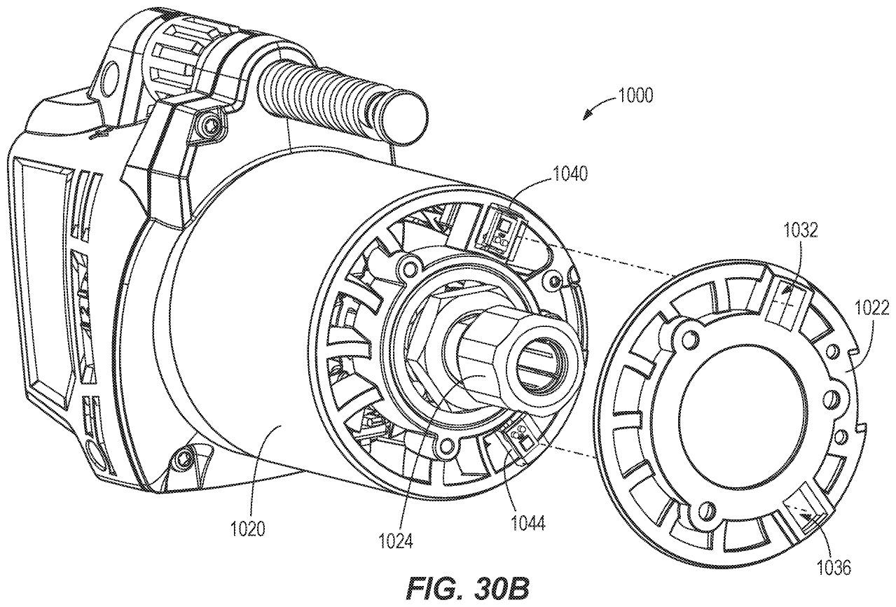

FIG. 24 illustrates a guide track assembly 294 for guiding a power tool, such as the router 20, to move in a straight line along a work surface. The guide track assembly 294 includes a guide track 296 and a track adapter 298 that couples the router 20 to the guide track 296 in a movable manner.

The guide track 296 is generally elongated and extends linearly lengthwise along a longitudinal axis 300. The guide track 296 includes a bottom side 302 that rests upon the work surface (or, another support surface) and a top side 304 that interfaces with the track adapter 298. A guide rail 306 protrudes upward from the top side 304 and extends substantially along a length of the guide track 296 in a direction of the longitudinal axis 300.

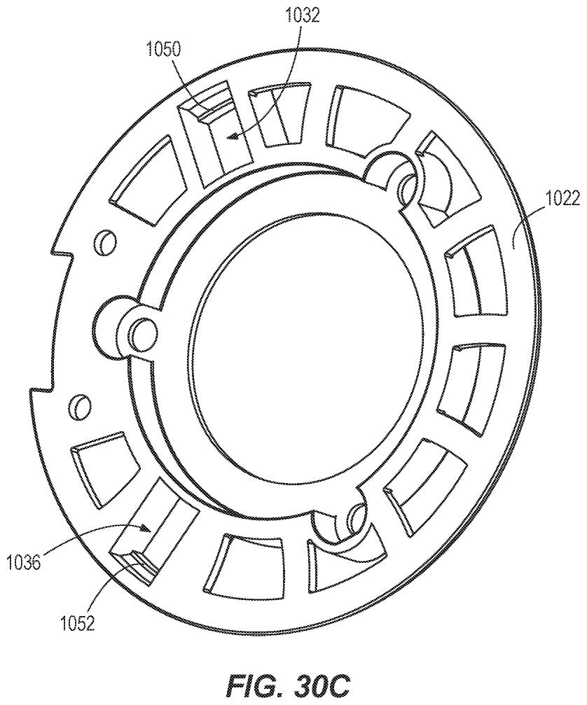

With reference to FIGS. 24-26, the track adapter 298 includes an adapter plate 308, a pair of adjustable guide rods 310, a pair of attachment rods 312, a rod plate 314, a pair of handles 316, and a micro-adjust assembly 318. The adapter plate 308 is substantially planar in shape and includes a bottom side 320 and a top side 322. The bottom side 320 defines a guide groove 324 that extends in a sliding direction indicated by the arrows 326. When the track adapter 298 is placed upon the guide track 296, the guide groove 324 receives the guide rail 306 such that the guide rail 306 guides the sliding movement of the track adapter 298 along the guide track 296 in the direction of the longitudinal axis 300. The track adapter 298 includes a pair of slop adjustment knobs 328 that are rotatable to increase or decrease an effective width of the guide groove 324 to remove slop between the guide track 296 and the track adapter 298. The track adapter 298 further includes a pair of lock knobs 330 that are rotatable to selectively secure or release the adapter plate 308 for sliding movement along the guide rail 306. The lock knobs 330 are operable to prevent the track adapter 298 from lifting out of the guide track 296 or to permit the track adapter 298 to do so.

The adapter plate 308 also includes a pair of first guide rod mounts 332 and a pair of second guide rod mounts 334 that protrude upward from the top side 322. Each of the guide rod mounts 332, 334 defines a guide rod aperture 336 that slidably receives one of the guide rods 310. Each guide rod 310 extends through a respective first guide rod mount 332 and a respective second guide rod mount 334. As such, the guide rods 310 extend in a direction of an adjustment axis 335 that is transverse to the guide groove 324 and to the longitudinal axis 300. Distal ends of the guide rods 310 are affixed to one side of the rod plate 314 (e.g., by threaded fasteners). The attachment rods 312 are affixed to an opposite side of the rod plate 314 (e.g., by threaded fasteners). The attachment rods 312 extend away from the rod plate 314 in parallel and are configured to removably attach to the router 20. Specifically, the attachment rods 312 are receivable into the connectors 230 (FIG. 18A) to secure the fixed base 32 to the track adapter 298, and are also receivable into the connectors 282 (FIG. 23) to secure the plunge base 28 to the track adapter 298.

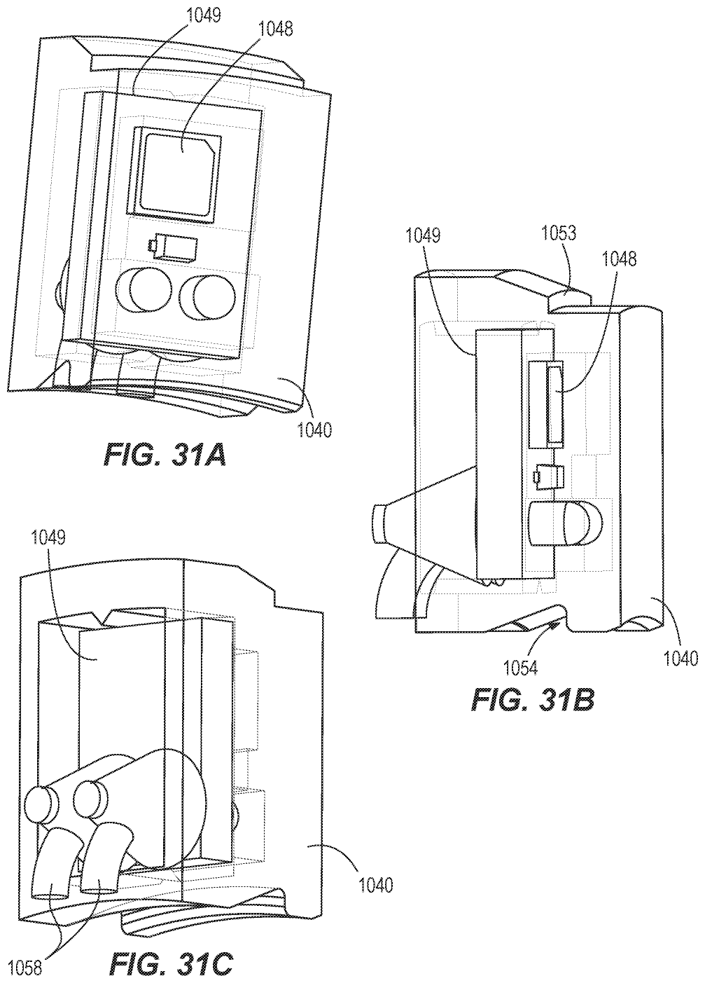

With reference to FIG. 26, the track adapter 298 includes a pair of main clamp knobs 338 that are each coupled to a respective first guide rod mount 332. The main clamp knobs 338 can be tightened or loosened to clamp or release the guide rods 310 relative to the adapter plate 308.

The micro-adjust assembly 318 includes a carrier plate 340, a micro-adjust shaft 342, a pair of micro-adjust clamp knobs 344, a measurement rod 346, an indicator 348, a first scale 350, and a second scale 352. The carrier plate 340 includes a pair of guide rod apertures 354 that each receive one of the respective guide rods 310, and a central aperture 356 that receives the micro-adjust shaft 342. The micro-adjust clamp knobs 344 are coupled to the carrier plate 340 adjacent the guide rod apertures 354 and can be tightened or loosened to clamp or release the guide rods 310 relative to the carrier plate 340.

With continued reference to FIG. 26, the micro-adjust shaft 342 is received into the central aperture 356 and is translationally fixed to the carrier plate 340 but remains rotatable relative to the carrier plate 340. The micro-adjust shaft 342 includes an adjustment knob 358, a bushing 360, and a threaded shaft portion 362. The adapter plate 308 includes a threaded boss 364 that protrudes from the top side 322 adjacent the first guide rod mounts 332, and the threaded shaft portion 362 of the micro-adjust shaft 342 threads into the threaded boss 364. A spring 366 is fitted about the threaded shaft portion 362 and positioned between the threaded boss 364 and the carrier plate 340 to bias the carrier plate 340 away from the threaded boss 364. The biasing force exerted by the spring 366 eliminates slop in the micro-adjust assembly 318 when the main clamp knobs 338 are loosened and micro-adjustments are performed.

The measurement rod 346 is fixedly attached to the rod plate 314 at its distal end and secured thereto via, e.g., a threaded fastener. As such, the measurement rod 346 moves in unison with the rod plate 314 (and with the guide rods 310 and the attachment rods 312) during operation of the micro-adjust assembly 318. The adapter plate 308 includes a measurement rod mount 368 that protrudes from the top side 322 and is located adjacent one of the first guide rod mounts 332. The measurement rod 346 extends through an aperture in the measurement rod mount 368, which guides the sliding movement of the measurement rod 346 and prevents excess movement or bending of the measurement rod 346.

With continued reference to FIG. 26, the indicator 348 is fitted about the measurement rod 346 by a loose or nominal interference fit. The indicator 348 is forcibly slidable along a length of the measurement rod 346 which permits a user to zero or “tare” a measurement when operating the micro-adjust assembly 318. The first and second scales 350, 352 are located on the top side 322 of the adapter plate 308 and positioned adjacent each respective side of the measurement rod 346. The indicator 348 includes two opposite pointers 370 that point toward the first scale 350 and the second scale 352, respectively. As the micro-adjust assembly 318 is operated and the guide rods 310 and attachment rods 312 translate along the adjustment axis 335, their motion is communicated to the indicator 348 via the measurement rod 346. The indicator 348 travels along a length of the scales 350, 352 to indicate a distance by which the rods 310, 312 have travelled. In the illustrated embodiment, the first scale 350 has units of inches (in) (e.g., from 0 in to 2 in) and the second scale 352 has units of millimeters (mm) (e.g., from 0 mm to 50 mm).

In operation, the user can connect the router 20 to the guide track 296 using the track adapter 298 and adjust the offset distance between the guide rail 306 and the router 20 using the micro-adjust assembly 318. First, the attachment rods 312 are secured to the connectors 230 (FIG. 18A) or to the connectors 282 (FIG. 22) to secure the track adapter 298 to the fixed base 32 or the plunge base 28, respectively. To begin performing a micro-adjustment, the micro-adjust clamp knobs 344 are tightened to secure the carrier plate 340 to the guide rods 310, and the main clamp knobs 338 are loosened to permit the guide rods 310 to slide relative to the adapter plate 308. Optionally, the indicator 348 is slid along the measurement rod 346 to align one of the pointers 370 with a desired indicia of the first scale 350 or the second scale 352. The adjustment knob 358 is rotated to move the carrier plate 340 toward or away from the adapter plate 308 along the adjustment axis 335. The carrier plate 340 moves as a single unit with the guide rods 310, the rod plate 314, the attachment rods 312, and the router 20. As such, rotation of the adjustment knob 358 causes the router 20 to translate along the adjustment axis 335 toward or away from the guide track 296. The distance by which the router 20 moves along the adjustment axis 335 is communicated to the indicator 348 via the measurement rod 346. As such, the distance moved can be measured by observing the distance travelled by the pointers 370 along the scales 350, 352. When a desired adjustment is achieved, the main clamp knobs 338 are tightened to lock the position of the router 20 relative to the guide track 296 in the direction of the adjustment axis 335.

Notably, the micro-adjust assembly 318 can be removed from the track adapter 298 and the adapter 298 can still maintain its general functionality. Specifically, the carrier plate 340, the micro-adjust shaft 342, and the measurement rod 346 with the indicator 348 can all be removed from the track adapter 298. With the micro-adjust assembly 318 removed, the router 20 can still be coarsely adjusted relative to the guide track 296 by loosening/tightening the main clamp knobs 338 and manually sliding the router 20 toward or away from the adapter plate 308.

In addition, the track adapter 298 is further operable with other types of power tools, such as other cutting tools (e.g., a circular saw, a jig saw, a sander, etc.) by securing the attachment rods 312 to connectors of the other power tools. Each of the other compatible power tools can be operated with the track adapter 298 and the guide track 296 to perform work on a workpiece along a straight line extending parallel to the guide track 296.

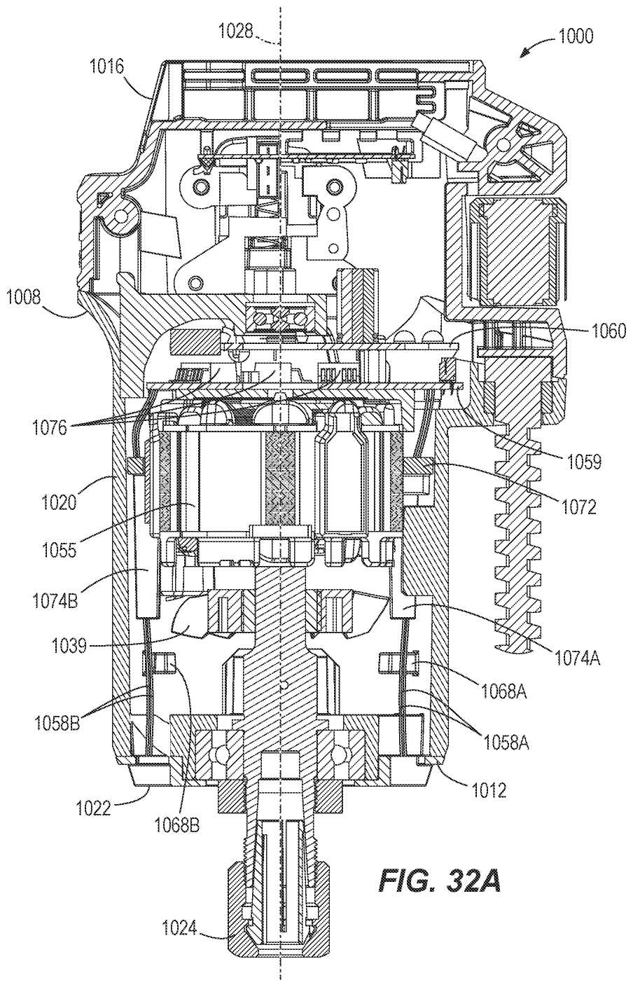

FIG. 27 illustrates a track adapter 298a according to another embodiment of the disclosure. The track adapter 298a may be operable with the micro-adjust assembly 318, although the micro-adjust assembly 318 is omitted from FIG. 27 for ease or illustration. The track adapter 298a is similar in many respects to the track adapter 298 described above, and as such, the following description is primarily focused on the differences between the track adapters 298, 298a.

The track adapter 298a includes an adapter plate 308a, a pair of adjustable guide rods 310a, a pair of attachment rods 312a, a rod plate 314a connecting the guide rods 310a to the attachment rods 312a, and a pair of handles 316a. Unlike the track adapter 298, however, the track adapter 298a does not include the main clamp knobs. Instead, the track adapter 298a includes a cam lock mechanism 372a operable to lock or release the guide rods 310a for sliding movement relative to the adapter plate 308a. The cam lock mechanism 372a includes a double-sided cam 374a rotatably coupled to the adapter plate 308a and positioned between the guide rods 310a. The cam 374a is connected to a release lever 376a actuable to rotate the cam 374a from a locked position to a released position. A biasing member, such as a torsion spring 375a, biases the cam 374a toward the locked position. The cam 374a includes two lobes 378a that each selectively engage a respective guide rod 310a to prevent sliding movement of the guide rods 310a due to frictional contact between the lobes 378a and the guide rods 310a. The lobes 378a engage the guide rods 310a in the locked position and move away from the guide rods 310a in the released position.

In operation, the cam 374a is normally biased toward the locked position by the biasing member. To release the cam 374a and perform macro adjustments on the position of the router 20, the lever 376a is simply rotated against the force of the biasing member to pivot the lobes 378a away from the guide rods 310a to the released position. Then, while holding the lever 376a at the released position, the router 20 can be slid freely toward or away from the guide track 296. When a desired position of the router 20 is reached, the lever 376a is released, and the force exerted by the biasing member moves the cam 374a back to the locked position to lock the guide rods 310a against movement relative to the adapter plate 308a.

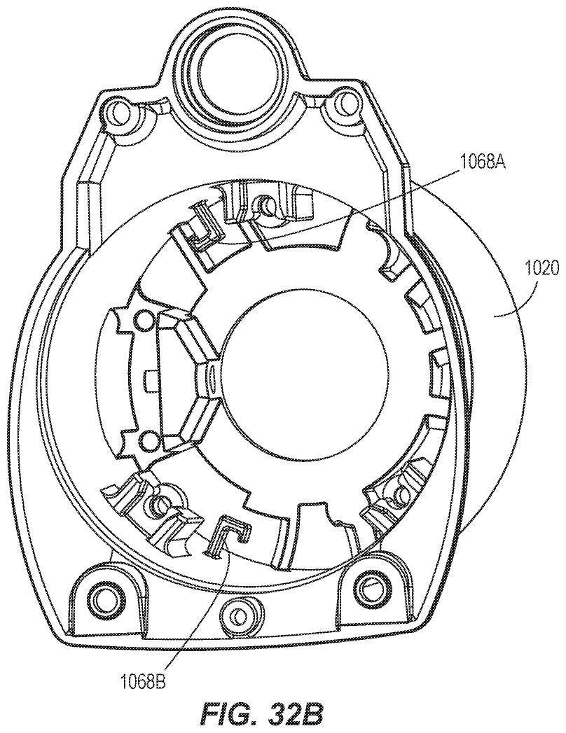

FIG. 28 illustrates a track adapter 298b according to another embodiment of the disclosure. The track adapter 298b also may be operable with the micro-adjust assembly 318, although the micro-adjust assembly 318 is omitted from FIG. 28 for ease or illustration. The track adapter 298b is similar in many respects to the track adapter 298 described above, and as such, the following description is primarily focused on the differences between the track adapters 298, 298b.

The track adapter 298b includes an adapter plate 308b, a pair of adjustable guide rods 310b, a pair of attachment rods 312b, a rod plate 314b connecting the guide rods 310b to the attachment rods 312b, and a pair of handles 316b. Unlike the track adapter 298, however, the track adapter 298b does not include the main clamp knobs. Instead, the track adapter 298b includes a linkage lock mechanism 380b operable to lock or release the guide rods 310b for sliding movement relative to the adapter plate 308b. The linkage lock mechanism 380b includes a pair of clamp bolts 382b threaded to each of the first guide rod mounts 332b. Each clamp bolt 382b is rotationally biased by a torsional biasing member (e.g., a torsion spring; not shown) toward a locked position. In the locked position, the clamp bolt 382b is tightened into the first guide rod mount 332b and engages the respective guide rod 310b to prevent movement of the guide rod 310b relative to the adapter plate 308b.

A first lever 384b is coupled to one of the clamp bolts 382b and a second lever 386b is coupled to the other clamp bolt 382b. Each of the levers 384b, 386b are rotatable to move the corresponding clamp bolt 382b from the locked position to a released position at which the clamp bolt 382b does not engage the corresponding guide rod 310b. A linkage 388b extends between the levers 384b, 386b and is pinned at each respective end to a corresponding lever 384b or 386b. The linkage 388b communicates rotation of the first lever 384b to the second lever 386b. Accordingly, when a user rotates the first lever 384b to release the coupled clamp bolt 382b, the second lever 386b also moves in unison with the first lever 384b and releases the other clamp bolt 382b. In the illustrated embodiment, the first lever 384b is longer than the second lever 386b and thus provides more leverage for releasing the clamp bolts 382b.

In operation, the clamp bolts 382b are normally biased toward the locked position by the respective torsion biasing members (not shown). To release the clamp bolts 382b and perform macro adjustments on the position of the router 20, the first lever 384b is simply rotated against the force of the biasing members to loosen the clamp bolts 382b and move them away from the guide rods 310b to the released position. The linkage 388b communicates the motion of the first lever 384b to the second lever 386b to thereby loosen both clamp bolts 382b simultaneously. Then, while holding the first lever 384b at the released position, the router 20 can be slid freely toward or away from the guide track 296. When a desired position of the router 20 is reached, the first lever 384b is released, and the force exerted by the biasing members moves the clamp bolts 382b back to the locked position to lock the guide rods 310b against movement relative to the adapter plate 308b.

### The Alternative Motor Unit

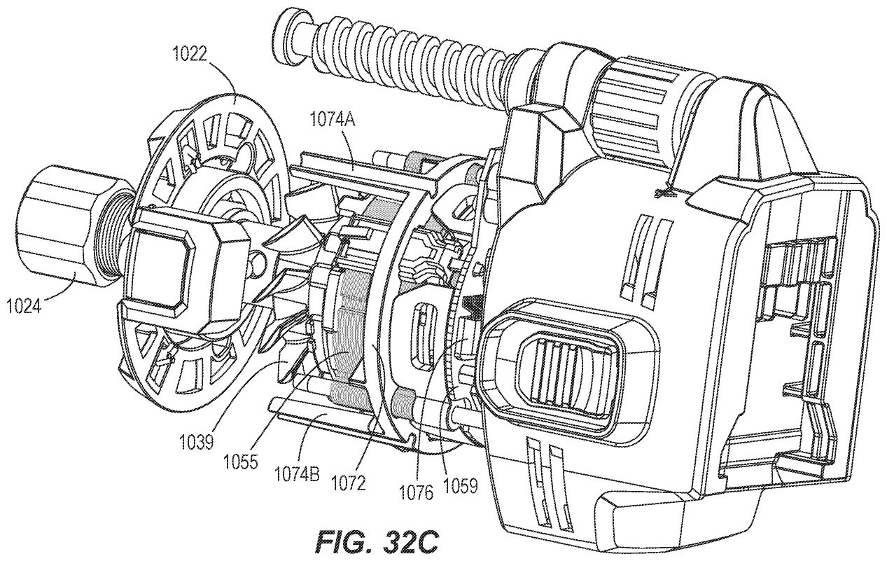

FIG. 29 illustrates a perspective view of a power tool 1000 according to some embodiments. In the example shown, the power tool 1000 is a motor unit substantially similar to the motor unit 24 (FIG. 1) described herein. The power tool 1000 is operable with each of the plunge base 28 (FIG. 1) and the fixed base 32 and is configured to route (i.e., hollow out) an area in a work piece such as wood or plastic. The following description both elaborates on features already described in connection with the motor unit 24 and introduces new or alternative features.

In the example shown, the power tool 1000 includes a housing 1004. The housing 1004 may include a first housing portion 1016 (i.e., clamshell housing 1016), a second housing portion 1020 (i.e., motor housing 1020) coupled to the first housing portion 1016, and a cover 1022 (i.e., motor housing cover 1022) coupled to the second housing portion 1020. The motor housing 1020 may include a first end 1008 (i.e., a rear end 1008) and a second end 1012 (i.e., output end 1012) opposite the first end 1008. The power tool 1000 also includes an output device 1024 that may include a collet on an output shaft 1025. The collet and a collet nut may be configured to hold a router bit in place on the output shaft 1025. Any combination of the collet, the collet nut, and the router bit may be considered to be the output device 1024 of the power tool 1000. The output device 1024, which is coupled to the output/motor shaft 1025 is configured to rotate about an output axis 1028 to route an area in a work piece.

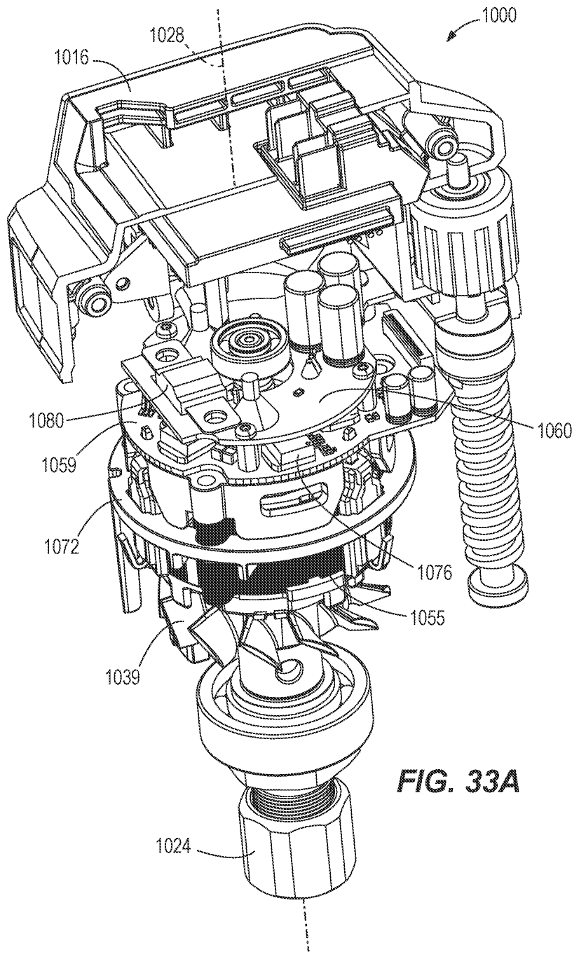

FIG. 30A illustrates a view of the output end 1012 of the motor housing 1020, as seen looking along the output axis 1028. FIG. 30B illustrates an exploded view of the output end 1012 of the motor housing 1020 with the cover 1022 removed from the motor housing 1020. As shown in FIGS. 30A and 30B, the cover 1022 is configured to cover at least a portion of a surface of the motor housing 1020 that faces the output device 1024. As shown in FIG. 30B, the cover 1022 may include a first opening 1032 and a second opening 1036 separated from each other by approximately 130 degrees about the output axis 1028. In some embodiments, the first opening 1032 and the second opening 1036 are separated from each other about the output axis 1028 by at least 130 degrees. For example, the first opening 1032 and the second opening 1036 may be separated from each other by 140 degrees. The first opening 1032 may receive a first lens 1040 mounted therein, and the second opening 1036 may receive a second lens 1044 mounted therein, such that a front surface of the first lens 1040 and a front surface of the second lens 1044 are each flush with a front exterior surface of the cover 1022. In some instances, the front surface of the first lens 1040 and the front surface of the second lens 1044 are each sub-flush/recessed with respect to the front exterior surface of the cover 1022. In some instances, the front surface of the first lens 1040 and the front surface of the second lens 1044 each protrude outwardly beyond the front exterior surface of the cover 1022 in a direction parallel to the output axis 1028.

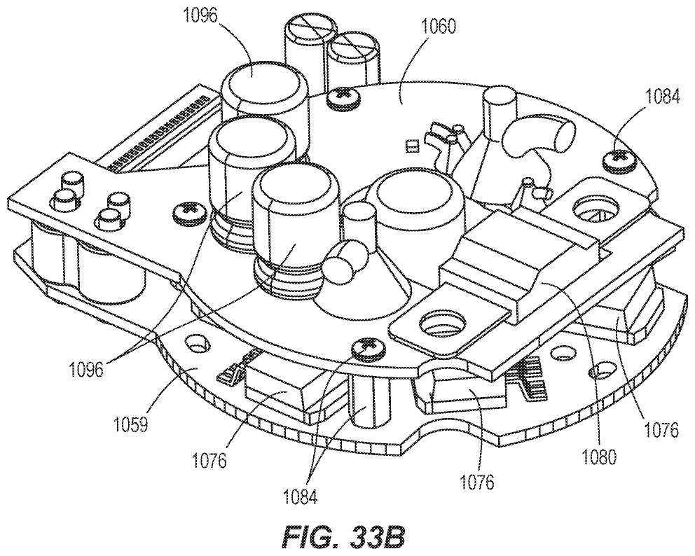

FIGS. 31A, 31B, and 31C illustrate views of the lenses 1040, 1044 according to some example embodiments. FIG. 31A illustrates a front perspective view of the lens 1040, 1044. FIG. 31B illustrates a side perspective view of the lens 1040, 1044. FIG. 31C illustrates a rear perspective view of the lens 1040, 1044. In some instances, the lenses 1040, 1044 are similar or identical to each other, but in other instances, the lenses 1040, 1044 may be different than each other. FIGS. 31A-31C include labeled elements with respect to the first lens 1040 but similar elements may be included with respect to the second lens 1044 and similar explanation that is included below with respect to the lens 1040 may also apply to the lens 1044.

The first lens 1040 includes a first lighting device 1048 mounted on a lighting printed circuit board (PCB) 1049, and the second lens 1044 includes a second lighting device mounted on a respective PCB. The first lighting PCB 1049 and the second lighting PCB may be snap-fit into a recess of a respective lens 1040 and 1044 and/or may be glued or otherwise secured within the recess of the respective lenses 1040 and 1044. In some embodiments, the first lighting device 1048 and the second lighting device may be light-emitting diodes (LEDs). The first lens 1040 and the second lens 1044 enable the first lighting device 1048 and the second lighting device, respectively, to emit light through the lens 1040, 1044. For example, the first lighting device 1048 and the second lighting device may be configured to illuminate a work surface of the power tool 1000, or indicate a fault in the power tool 1000 (e.g., by flashing in a predetermined manner).

Each lens 1040, 1044 is held in place in a direction approximately parallel to the output axis 1028 by being clamped between (i) a respective radially protruding feature 1050, 1052 in the openings 1032, 1036 of the cover 1022 and (ii) the surface of the motor housing 1020 that faces the output device 1024. For example, FIG. 30C illustrates a rear perspective view of the cover 1022 to show radially protruding features 1050 and 1052 in respective openings 1032 and 1036. In the example shown, the radially protruding features 1050 and 1052 protrude radially inward toward the output axis 1028 from an inner surface of an outer rim of the cover 1022. The radially protruding feature 1050, 1052 may engage a protruding feature 1053 on each of the lenses 1040 and 1044 (see FIG. 31B). Engagement of the protruding feature 1053 with the radially protruding feature 1050, 1052 holds the lens 1040, 1044 in place by preventing the lens 1040, 1044 from moving toward the output device 1024 in a direction parallel to the output axis 1028.

In some embodiments, the openings 1032, 1036 additionally include a rib/protrusion to hold the lens 1040, 1044 in place by preventing the lens 1040, 1044 from moving away from the output device 1024 in a direction parallel to the output axis 1028. For example, the additional rib/protrusion may be located opposite the radially protruding features 1050, 1052 in the openings 1032, 1036 and may protrude radially outward away from the output axis 1028 from an outer surface of an inner rim of the cover 1022. For example, the additional rib/protrusion may be configured to engage with an indent 1054 on the lens 1040, 1044 that is located on an opposite side of the lens 1040, 1044 as the protruding feature 1053 (see FIG. 31B). In some instances, the indent 1054 of the lens 1040, 1044 is snap-fit over the additional rib/protrusion in the opening 1032, 1036. In addition to the additional rib/protrusion or as an alternative to the additional rib/protrusion, the lens 1040, 1044 is held in place by being prevented from moving in away from the output device 1024 in a direction parallel to the output axis 1028 by a rear side of the lens 1040, 1044 engaging/contacting a front surface of the motor housing 1020 that faces the output device 1024. As indicated in FIGS. 30A and 30B, the lenses 1040 and 1044 may be configured to fit into the openings 1032 and 1036, respectively, with little clearance space such that walls of the openings 1032 and 1036 prevent the lenses 1040 and 1044 from moving along axes that are perpendicular to the output axis 1028.

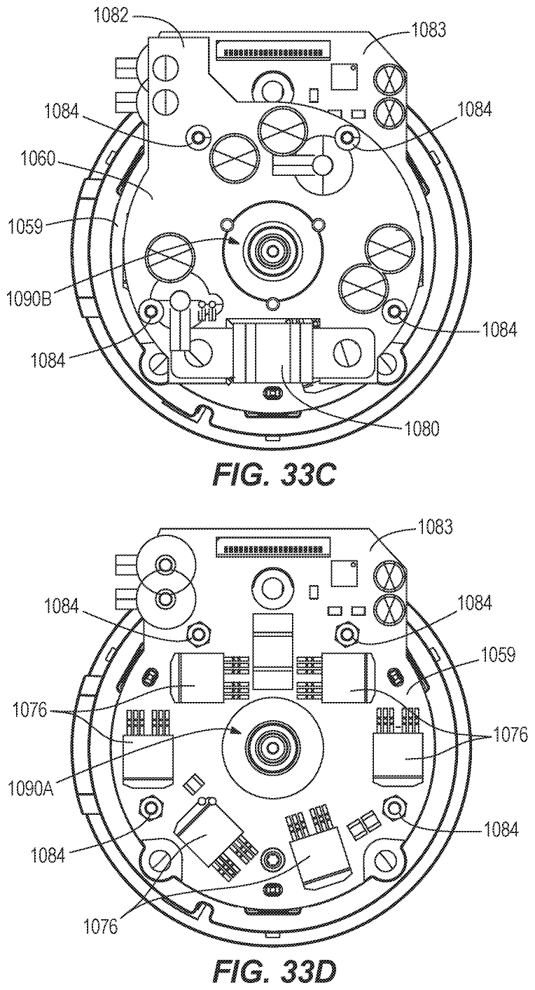

FIG. 32A illustrates a cross-sectional view of the power tool 1000 according to one example embodiment. As shown in the example of FIG. 32A, the motor housing 1020 is configured to support a motor 1055. The motor 1055 may be a brushless direct current (BLDC) motor 1055 configured to provide rotational energy to rotate the motor/output shaft 1025 coupled to the output device 1024 to rotate the output device 1024 about the output axis 1028. The power tool 1000 also includes a fan 1039 for providing air flow in the power tool 1000. The fan 1039 may be located between the motor 1055 and the output device 1024 (i.e., adjacent a front side/end of the motor 1055), and is configured to rotate about the output axis 1028. The fan 1039 may be located on the motor shaft 1025 and may be configured to be rotated by the motor 1055. In some instances, the fan 1039 may pull air from the rear end 1008 through the motor 1055 and exhaust air out of the motor housing 1020 at the output end 1012 of the motor housing 1020.

The power tool 1000 also includes first power wires 1058A and second power wires 1058B configured to provide power to the first lighting device 1048 and the second lighting device, respectively. In some embodiments, the first and second power wires 1058 connect to a first printed circuit board (PCB) 1059 (e.g., Hall and FET PCB 1059), a second PCB 1060 (e.g., disconnect device PCB 1060 such as a fuse PCB 1060), or another PCB and/or connector to receive power from a power supply of the power tool 1000 (e.g., a battery pack). At least a portion of the first power wires 1058A and the second power wires 1058B runs approximately parallel to the output axis 1028 along an inner surface of the motor housing 1020. The inner surface of the motor housing 1020 may include a first wire trap 1068A configured to guide at least a portion of the first power wires 1058A. The inner surface of the motor housing 1020 may also include a second wire trap 1068B configured to guide at least a portion of the second power wires 1058B. FIG. 32B illustrates a rear perspective view of the motor housing 1020 according to some example embodiments. Example wire traps 1068A, 1068B are shown in FIG. 32B on the inner surface of the motor housing 1020. Each of the wire traps 1068A, 1068B may be aligned with a respective opening on a front surface of the motor housing 1020 where a respective lens 1040, 1044 is located. For example, each of the wire traps 1068A, 1068B may be aligned with such a respective opening in a direction that is parallel to the output axis 1028 such that respective power wires 1058 run approximately straight back from the lenses 1040, 1044 through the wire traps 1068A, 1068B along the inner surface of the motor housing 1020.

The power tool 1000 may also include a first baffle 1072 located between an outer circumferential surface of the motor 1055 and the inner surface of the motor housing 1020 (see FIGS. 32A and 32C). FIG. 32C illustrates a rear perspective view of the power tool 1000 according to some example embodiments with the motor housing 1020 removed to allow components within the motor housing 1020 (e.g., the first baffle 1072) to be visible. The first baffle 1072 may include a ring-shaped base configured to encircle the outer circumferential surface of the motor 1055. The first baffle 1072 may limit and/or prevent air (e.g., air pulled by the fan 1039) from flowing along an outer surface of the motor 1055 and thereby promote air flowing through the motor 1055 (e.g., to cool the motor 1055). A surface of the first baffle 1072 that faces the output device 1024 may include a first wire guide channel 1074A extending approximately parallel to the output axis 1028 in a direction toward the output device 1024. The first power wires 1058A are configured to be received within the first wire guide channel 1074A. The surface of the first baffle 1072 that faces the output device 1024 may also include a second wire guide channel 1074B extending approximately parallel to the output axis 1028 in a direction toward the output device 1024. The second power wires 1058B are configured to be received within the second wire guide channel 1074B. The wire guide channels 1074A, 1074B are configured to extend toward the output device 1024 to at least an outer peripheral edge of the fan 1039 (see FIG. 32A). In some embodiments, the wire guide channels 1074A, 1074B extend toward the output device 1024 beyond the outer peripheral edge of the fan 1039. The wire traps 1068A, 1068B and respective wire guide channels 1074A, 1074B may be aligned with each other in a direction approximately parallel to the output axis 1028 (see FIG. 32A). In this manner, the wire traps 1068A, 1068B and the respective wire guide channels 1074A, 1074B are configured to guide respective power wires 1058A, 1058B approximately parallel to the output axis 1028 along the inner surface of the motor housing 1020 in order to prevent the power wires 1058 from contacting the fan 1039.

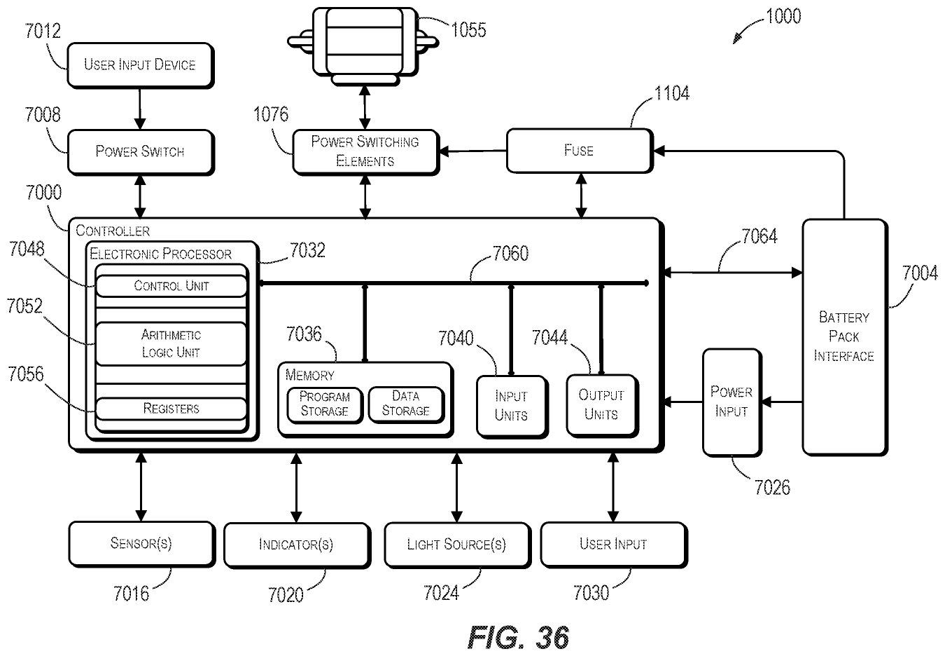

As shown in FIG. 32A, the power tool 1000 may include the first PCB 1059 and the second PCB 1060. The motor 1055 may include a first end (i.e., a front end) that is located closer to the output device 1024 than a second end (i.e., a rear end). The first PCB 1059 may be positioned adjacent to the second end/side of the motor 1055. The first PCB 1059 may include a controller 7000 (see FIG. 36) (e.g., an electronic processor 7032), at least one magnetic sensor (e.g., one or more Hall sensors), and/or a plurality of power switching elements 1076 (e.g., field effect transistors (FETs) 1076). The at least one magnetic sensor may detect a position of a rotor of the motor 1055. The plurality of power switching elements 1076 may be configured to control whether power is provided to the motor 1055. For example, an electronic processor 7032 (see FIG. 36) may control the power switching elements 1076 to be enabled/disabled at certain times based on feedback received from the at least one magnetic sensor to control when power is provided to different motor coils to cause rotation of the rotor.

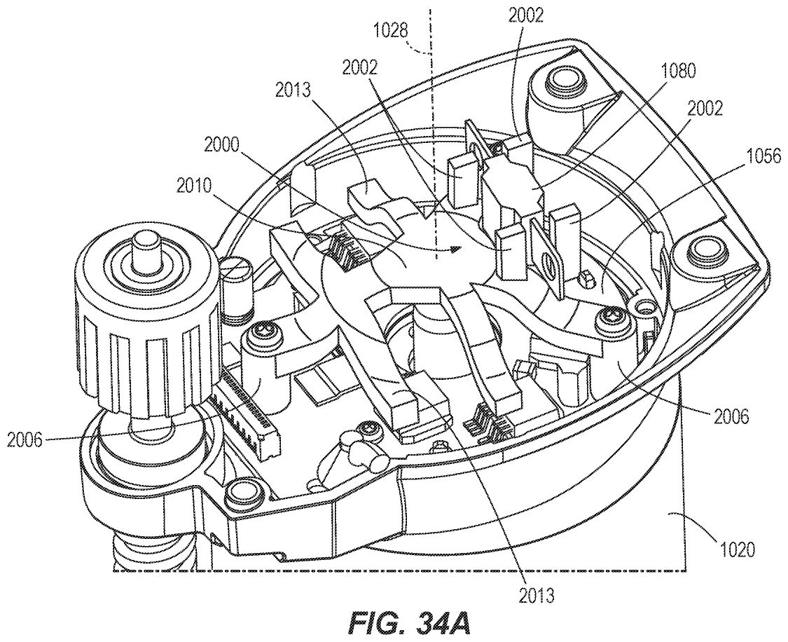

The first PCB 1059 may be located between the motor 1055 and the second PCB 1060 in a direction parallel to the output axis 1028 (see FIGS. 32A and 33A). For example, the first PCB 1059 and the second PCB 1060 may have a stacked arrangement with respect to each other. In some instances, a first surface of the first PCB 1059 on which (i) the magnetic sensor, (ii) at least one of the plurality of power switching elements 1076, or (iii) both (i) and (ii) are mounted is approximately parallel to a second surface of the second PCB 1060 on which a disconnect device (e.g., a fuse 1080) is mounted (see FIGS. 32A and 33A-33B). In some instances, the power switching elements 1076 are mounted on one surface of the first PCB 1059 (e.g., a rear-facing surface that faces away from the motor 1055) and the at least one magnetic sensor is mounted on an opposite surface of the first PCB 1059 (e.g., a forward-facing surface that faces toward the motor 1055). In some instances, the power switching elements 1076 are mounted on the opposite surface of the first PCB 1059 (i.e., the forward-facing surface that faces toward the motor 1055).

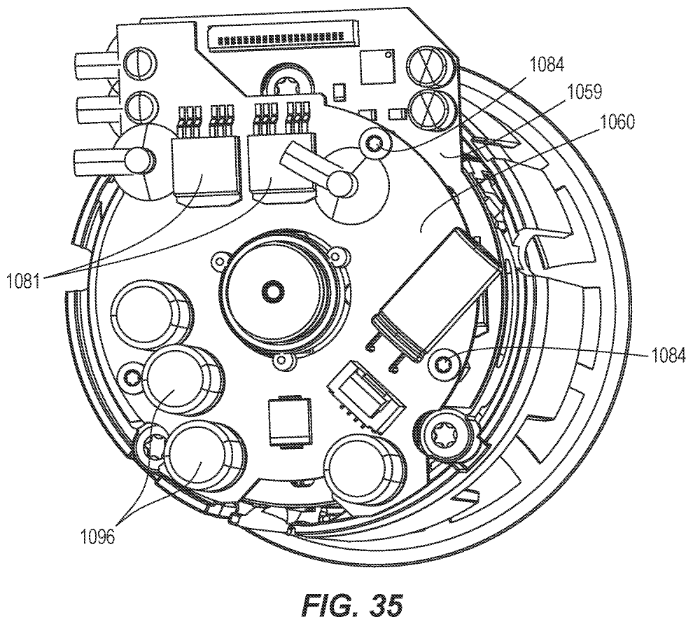

The second PCB 1060 may be electrically and/or physically connected to the first PCB 1059. In some embodiments, the second PCB 1060 is mounted to the first PCB 1059 using mounting hardware 1084. For example, the second PCB 1060 may be secured, using screws, to standoffs that are secured to the first PCB 1059 (see FIG. 33B). In some embodiments, the second PCB 1060 is electrically connected to the first PCB 1059 via a rigid connection (e.g., not merely by wires). For example, the second PCB 1060 may be electrically connected to the first PCB 1059 via a solid conductor, via direct soldering, or via both the solid conductor and direct soldering. The second PCB 1060 may include a disconnect device (e.g., a fuse 1080, a conductive high impedance trace, a solid state disconnect device 1081, and/or the like) configured to interrupt electric power to the motor 1055. For example, the fuse 1080 may interrupt the electric power to the motor 1055 in response to a current flowing through the fuse 1080 that exceeds a first current limit. In addition to or as an alternative to the fuse 1080, in some instances, the disconnect device includes a conductive high impedance trace that is configured to interrupt the electric power to the motor 1055 in response to a current flowing through the conductive high impedance trace that exceeds a second current limit. In some instances, the second current limit is less than the first current limit. In some instances, the disconnect device additionally or alternatively includes a solid state disconnect device (e.g., one or more field effect transistors 1081 (FETs 1081)) as shown in an example embodiment shown in FIG. 35. Like the other disconnect devices described above, the FET(s) 1081 may electrically connect the battery pack 38 (via the battery pack interface 7004) and the FETs 1076 on the first PCB 1059 (and/or other components of the power tool 1000 that receive power). For example, the FETs 1081 may be controlled by the controller 7000 to disconnect/interrupt the electrical connection between the battery pack 38 and the FETs 1076 (and/or other components of the power tool 1000 that receive power) in response to the controller 7000 detecting a fault of the power tool 1000 (e.g., an overcurrent, an overtemperature, and/or the like).

In some instances of the embodiment shown in FIG. 35, the second PCB 1060 may have a similar shape as the second PCB 1060 shown in the example of FIG. 33C but the FETs 1081 (e.g., surface-mounted FETs 1081 as shown) that make up the solid state disconnect device of FIG. 35 may be located in a different location on the second PCB 1060 than the fuse 1080 of FIG. 33C. The embodiment shown in FIG. 35 may be similar to the embodiment shown in FIG. 33C except for the differences noted herein. Accordingly, similar reference numerals may be used for similar components. The locations of the fuse 1080 and the FETs 1081 shown in FIGS. 33C and 35, respectively, are merely examples. In some instances, a surface of the second PCB 1060 on which the fuse 1080 and/or the FET(s) 1081 is mounted is a rear-facing surface that faces away from the motor 1055 (see FIGS. 33A and 35). In some instances, the fuse 1080 and/or the FET(s) 1081 is mounted on the opposite face of the second PCB 1060 (i.e., a forward-facing surface that faces toward the motor 1055).

As indicated in FIGS. 32A and 33A, the output axis 1028 intersects a first plane defined by the first PCB 1059 and a second plane defined by the second PCB 1060. In some embodiments, the output axis 1028 is perpendicular to the first PCB 1059 and the second PCB 1060. In some embodiments, the first PCB 1059 and the second PCB 1060 each include a respective opening/through-hole 1090A, 1090B (see FIGS. 33C and 33D) through which the output axis 1028 passes. In some instances, the respective opening 1090A, 1090B is located approximately in the center of the first PCB 1059 and the second PCB 1060, respectively, such that the first PCB 1059 and the second PCB 1060 are approximately centered about the output axis 1028 of the power tool 1000.

FIG. 33B is a perspective view of the first PCB 1059 and the second PCB 1060 isolated from the rest of the power tool 1000 in the stacked arrangement according to some example embodiments. The second PCB 1060 may include mounting hardware 1084 (e.g., fasteners, screws, screw bosses. standoffs, etc.) for physically mounting the second PCB 1060 to the first PCB 1059. The second PCB 1060 may also include the fuse 1080 and numerous other circuit components such as bus capacitors 1096, a thermistor configured to measure a temperature of or associated with the fuse 1080, etc.

FIG. 33C is a rear view of the power tool 1000 with the housings 1016 and 1020 removed and some other components of the power tool 1000 removed to allow the PCBs 1059, 1060 to be visible. As indicated in the example of FIG. 33C, in some instances, a second surface area of the second PCB 1060 is smaller than a first surface area of the first PCB 1059 to allow at least one electrical component mounted on the first PCB 1059 (e.g., a capacitor) to pass through a second plane defined by the second surface of the second PCB 1060. For example, the second PCB 1060 may include narrow extension portion 1082 that extends from a main circular portion of the second PCB 1060 instead of a wider extension portion 1083 that extends from a main circular portion of the first PCB 1059. Also as indicated in the example of FIG. 33C, in some instances a second radius of a portion of the second PCB 1060 that forms a circular shape may be less than a first radius of a portion of the first PCB 1059 that forms a circular shape. Such sizing of the PCBs 1059, 1060 may allow space for other components included in the housing 1004 (e.g., wires running past the second PCB 1060 to the first PCB 1059). FIG. 33C also shows the through-hole 1090B of the second PCB 1060.

FIG. 33D is a rear view of the power tool 1000 similar to the rear view of FIG. 33C but with the second PCB 1060 also removed to make the first PCB 1059 more visible. In some instances, the first PCB 1059 includes six flat-mounted power switching elements 1076 (e.g., FETs 1076) located around the through-hole 1090A of the first PCB 1059.

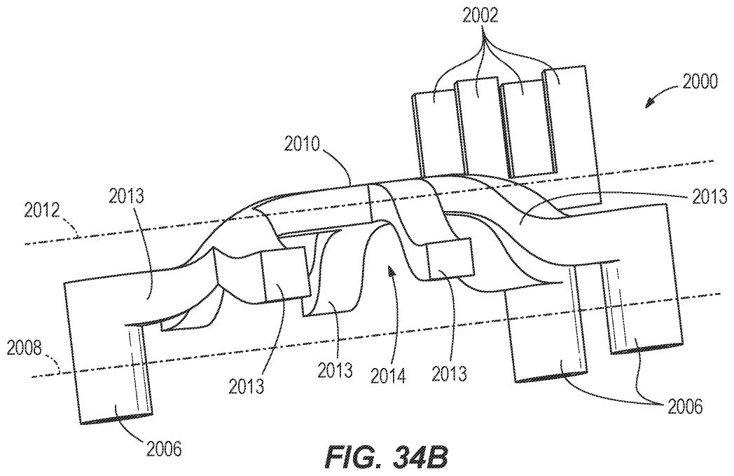

FIG. 34A illustrates a partial cutaway view of another embodiment of the power tool 1000. Most details of the power tool 1000 shown in FIG. 34A may be similar to or the same as those described previously herein except that the power tool 1000 shown in FIG. 34A may include a fuse holder/fuse holding frame 2000 mounted on the first PCB 1059 instead of the second PCB 1060 mounted on the first PCB 1059. The fuse holder 2000 may be mounted to the first PCB 1059 in a similar manner as described previously herein with respect to the second PCB 1060 (e.g., using mounting hardware 1084 such as screws, standoffs, etc.). The fuse holder 2000 may be mounted to the first PCB 1059 on an opposite side (e.g., a rear-facing side) of the first PCB 1059 than where the motor 1055 is located. Accordingly, the first PCB 1059 may be positioned between the fuse holder 2000 and the motor 1055 of the power tool 1000.

The fuse holder 2000 includes a plurality of tabs 2002 (e.g., four tabs 2002 are shown in FIG. 34A) that protrude from the fuse holder 2000 approximately parallel to the output axis 1028 in a direction away from the motor 1055 (e.g., rearwardly). The plurality of tabs 2002 are configured to hold the fuse 1080 in place. In some instances, the plurality of tabs 2002 are configured to removably hold the fuse 1080 in place in a friction fit manner. The fuse 1080 may be configured to be removed and replaced with a second fuse that is friction fit within the plurality of tabs 2002 (for example, after other parts of the power tool 1000 that caused the fuse to blow/interrupt power flow are identified and fixed/replaced). In some instances, the tabs 2002 support the fuse 1080 such that the fuse 1080 is not tightly clamped or pinched when seated within the fuse holder 2000 but such that the fuse 1080 is still held in place. In some instances, the fuse holder 2000 may include more or less tabs 2002, and/or the tabs 2002 may be located in a different location and/or orientation on the fuse holder 2000. For example, the tabs 2002 may protrude in a direction toward the motor 1055 (e.g., forwardly) in some embodiments. In some instances, the fuse 1080 is electrically coupled between the battery pack 38 (via the battery pack interface 7004) and the first PCB 1059 using wires that respectively extend from the battery pack interface 7004 and the first PCB 1059 and that are connected to the fuse 1080, for example, using a bolt and nut through a ring terminal on the wire and a respective terminal of the fuse 1080.

FIG. 34B illustrates a perspective view of the fuse holder 2000 according to some example embodiments. In some instances, the fuse holder 2000 includes a plurality of mounting portions 2006 that are mounted to the first PCB 1059. The mounting portions 2006 may protrude from the fuse holder 2000 in a direction opposite to the direction in which the tabs 2002 protrude. The plurality of mounting portions 2006 may be located in a first plane 2008 that is approximately parallel to the first PCB 1059. The fuse holder 2000 may also include a center portion 2010 connected to the mounting portions 2006. The output axis 1028 may pass through the center portion 2010. The center portion 2010 may be located in a second plane 2012 that is approximately parallel to the first PCB 1059 and that is further away from the first PCB 1059 than the first plane 2008 when the fuse holder 2000 is mounted on the first PCB 1059. In some instances, at least a portion of a motor support (e.g., a portion of a motor end cap, a motor bearing, a rear end of a motor shaft 1025, and/or the like) is located in a space/indentation 2014 created by having the second plane 2012 further away from the first PCB 1059 (and the motor 1055) than the first plane 2008. For example, the space 2014 is located adjacent to a surface of the center portion 2010 of the fuse holder 2000 that faces the first PCB 1059 and the motor 1055 (i.e., a front facing surface of the center portion 2010). In some instances, at least one of the tabs 2002 protrudes from the center portion 2010 of the fuse holder 2000. In some instances, the fuse holder 2000 may enable the first PCB 1059 to be protected from contact with wires that are routed within the power tool 1000. For example, the fuse holder 2000 may be made of an insulating/non-conductive material (e.g., plastic) and may include extensions 2013 that extend from the center portion 2010 to mechanically isolate components of the first PCB 1059 from other wires being routed within the power tool 1000.

FIG. 36 illustrates a block diagram of the power tool 1000 according to some example embodiments. The power tool 1000 may include a controller 7000. The controller 7000 is electrically and/or communicatively connected to a variety of components of the power tool 1000. For example, as illustrated by FIG. 36, the controller 7000 is electrically connected to the power switching elements 1076 that control whether power is provided to the motor 1055, a battery pack interface 7004, a power switch 7008 (connected to a user input device 7012 such as a user-actuatable switch), one or more sensors or sensing circuits 7016, one or more indicators 7020, one or more light sources 7024 (e.g., the first light source 1048 and the second light source described previously herein, among other possible light sources), power input circuitry 7026, and a user input 7030 (e.g., switches, buttons, a mode pad, etc.). The controller 7000 includes combinations of hardware and software that are operable to, among other things, control the operation of the power tool 1000, monitor the operation of the power tool 1000, activate the one or more indicators 7020 and/or light sources 7024, etc.

The controller 7000 includes a plurality of electrical and electronic components that provide power, operational control, and protection to the components within the controller 7000 and/or the power tool 1000. For example, the controller 7000 includes, among other things, an electronic processor 7032 (e.g., a microprocessor, a microcontroller, or another suitable programmable device), a memory 7036, input units 7040, and output units 7044. The electronic processor 7032 includes, among other things, a control unit 7048, an arithmetic logic unit (ALU) 7052, and a plurality of registers 7056 (shown as a group of registers 7056 in FIG. 36), and is implemented using a computer architecture (e.g., a modified Harvard architecture, a von Neumann architecture, etc.). The electronic processor 7032, the memory 7036, the input units 7040, and the output units 7044, as well as the various circuits connected to the controller 7000 are connected by one or more control and/or data buses 7060 (e.g., common bus). The control and/or data buses 7060 are shown generally in FIG. 36 for illustrative purposes. The use of one or more control and/or data buses 7060 for the interconnection between and communication among the various modules, circuits, and components would be understood by a person skilled in the art in view of the embodiments described herein. In some instances, the controller 7000 may be referred to as an electronic processor.

The memory 7036 is a non-transitory computer readable medium and includes, for example, a program storage area and a data storage area. The program storage area and the data storage area can include combinations of different types of memory 7036, such as a ROM, a RAM (e.g., DRAM, SDRAM, etc.), EEPROM, flash memory 7036, a hard disk, an SD card, or other suitable magnetic, optical, physical, or electronic memory 7036 devices. The electronic processor 7032 is connected to the memory 7036 and executes software instructions that are capable of being stored in a RAM of the memory 7036 (e.g., during execution), a ROM of the memory 7036 (e.g., on a generally permanent basis), or another non-transitory computer readable medium such as another memory 7036 or a disc. Software included in the implementation of the power tool 1000 can be stored in the memory 7036 of the controller 7000. The software includes, for example, firmware, one or more applications, program data, filters, rules, one or more program modules, and other executable instructions. The controller 7000 is configured to retrieve from the memory 7036 and execute, among other things, instructions related to the control processes and methods described herein. In other embodiments, the controller 7000 includes additional, fewer, or different components.

The battery pack interface 7004 includes a combination of mechanical components (e.g., rails, grooves, latches, etc.) and electrical components (e.g., one or more terminals) configured to and operable for interfacing (e.g., mechanically, electrically, and communicatively connecting) the power tool 1000 with the battery pack 38. For example, power provided by the battery pack to the power tool 1000 is provided through the battery pack interface 7004 to the power input circuitry 7026. The power input circuitry 7026 includes combinations of active and passive components to regulate or control the power received from the battery pack prior to power being provided to the controller 7000. The battery pack interface 7004 may also supply power to the FET switches 1076 that are configured to selectively provide power to the motor 1055 in accordance with instructions from the controller 7000. The battery pack interface 7004 also includes, for example, a communication line 7064 configured to allow for communication between the controller 7000 and the battery pack.

The indicators 7020 include, for example, one or more light-emitting diodes (“LEDs”). The indicators 7020 can be configured to display conditions of, or information associated with, the power tool 1000. For example, the indicators 7020 are configured to indicate measured electrical characteristics of the power tool 1000, the status of the device, etc. The user input 7030 is operably coupled to the controller 7000 to, for example, select a torque and/or speed setting for the power tool 1000 (e.g., using a speed dial), etc. In some embodiments, the user input 7030 includes a combination of digital and analog input or output devices required to achieve a desired level of operation for the power tool 1000, such as one or more knobs, one or more dials, one or more switches, one or more buttons, a mode pad, etc.

In some embodiments, the controller 7000 (specifically, the electronic processor 7032) is configured to control whether power is provided to the light source(s) 7024 (e.g., the first light device 1048 and the second lighting devices shown in FIG. 30A and explained previously herein) via the power wires 1058. In some embodiments, the controller 7000 may receive power from a power supply of the power tool 1000 and provide power to the light source(s) 7024 from the controller 7000. In such embodiments, the controller 7000 may condition received power as appropriate before providing power to the light source(s) 7024. In other embodiments, the light source(s) 7024 may be electrically connected to the power supply (e.g., to the battery pack via the battery pack interface 7004 and the power wires 1058) with a switch between the light source(s) 7024 and the power supply. In such embodiments, the controller 7000 may control the switch to allow or disallow power from be provided to the light source(s) 7024. In such embodiments, the electrical path from the power supply to the light source(s) 7024 may include conditioning circuitry similar to the power input circuitry 7026 to regulate or control the power received by the light source(s) 7024 from the power supply. In some embodiments, the controller 7000 controls the light source(s) 7024 to be illuminated in response to determining that the user input device 7012 (e.g., a user-actuatable power switch) has been actuated to turn on the motor 1055 of the power tool 1000.

The controller 7000 may be configured to monitor tool conditions using one or more sensors 7016. For example, the controller 7000 may be configured to determine whether a fault condition of the power tool 1000 is present and generate one or more control signals related to the fault condition. In some embodiments, the sensors 7016 include one or more current sensors, one or more speed sensors, one or more Hall Effect sensors as mentioned previously herein, one or more temperature sensors, etc. The controller 7000 calculates or includes, within memory 7036, predetermined operational threshold values and limits for operation of the power tool 1000. For example, when a potential thermal failure (e.g., of a FET, the motor 1055, etc.) is detected or predicted by the controller 7000, power to the motor 1055 can be limited or interrupted until the potential for thermal failure is reduced.

In some embodiments, the controller 7000 is configured to control an output of the light source(s) 7024 to indicate information to a user about a tool condition of the power tool 1000. For example, the controller 7000 may be configured to flash the light source(s) a predetermined number of times to indicate different types of fault conditions and/or to indicate that a monitored value has exceeded a second threshold that is less than but nearing a first threshold that triggers a fault detection. The memory 7036 may store a set of patterns corresponding to different types of fault conditions. For example, the controller 7000 may control the light source(s) to flash a unique pattern corresponding to an overtemperature event, a near overtemperature event, low battery, high current loading, near high current loading, and the like. In some embodiments, the controller 7000 controls the light source(s) to indicate such events prior to limiting or interrupting power to the motor 1055. The controller 7000 may control the light source(s) 7024 to flash any number of times and in any pattern as appropriate according to the fault condition and/or the value approaching the fault condition.

Although the disclosure has been described in detail with reference to certain preferred embodiments, variations and modifications exist within the scope and spirit of one or more independent aspects of the disclosure as described. Various features of the disclosure are set forth in the following claims.

1. A router comprising:
a motor unit including
a housing including a lower housing portion coupled to an upper housing portion, the lower housing portion including
an open end having a rim that defines an opening,
a partially closed end opposite the open end, and
a cylindrical wall extending between the open end and the partially closed end; and
an electric motor situated within the housing and configured to provide rotational energy to rotate a tool holder about an output axis;
wherein the rim defines a straight reference plane, and wherein the electric motor is positioned within the lower housing portion entirely on one side of the straight reference plane.

2. The router of claim 1, wherein the electric motor includes a stator affixed to the housing and a rotor configured to rotate relative to the stator.

3. The router of claim 2, wherein the motor unit further includes an output shaft configured to rotate about an axis, and the rotor is affixed to the output shaft and configured to provide rotational energy to rotate a tool holder about an axis of the output shaft.

4. The router of claim 3, wherein the tool holder is directly coupled to the output shaft.

5. The router of claim 1, further comprising a base configured to removably receive the motor unit and support the motor unit above a workpiece.

6. The router of claim 1, wherein the upper housing portion includes two clamshell housing halves.

7. The router of claim 1, wherein the upper housing portion includes a battery receiving portion configured to selectively and removably couple to a battery pack.

8. The router of claim 1, wherein the motor unit further includes a depth adjustment shaft rotatably supported by each of the upper housing portion and the lower housing portion.

9. A router comprising:
a motor unit including
a housing including a battery receiving portion configured to selectively and removably couple to a battery pack, and
a brushless direct current (BLDC) motor situated within the housing and configured to provide rotational energy to rotate an output device of the motor unit about an output axis;
a first base configured to removably receive the motor unit and support the motor unit above a workpiece, the first base including a first lower base portion and an annular sleeve; and
a second base configured to removably receive the motor unit and support the motor unit above a workpiece, the second base including a second lower base portion, a base support component, and a guide post coupling the second lower base portion to the base support component.

10. The router of claim 9, wherein the housing includes a lower housing portion coupled to an upper housing portion, the lower housing portion including an open end, a partially closed end opposite the open end, and a cylindrical wall extending between the open end and the partially closed end, and wherein the cylindrical wall defines an outer diameter that is less than or equal to 82 millimeters.

11. The router of claim 10, wherein the lower housing portion defines an internal cavity, and wherein the BLDC motor is positioned within the internal cavity and surrounded by the cylindrical wall.

12. The router of claim 10, wherein the lower housing portion includes a screw boss that protrudes inwardly from the cylindrical wall, and wherein the BLDC motor includes a stator that abuts the screw boss.

13. The router of claim 9, wherein the BLDC motor includes a stator and a rotor surrounded by the stator, and wherein the stator defines an outer diameter that is less than or equal to 60 millimeters.

14. The router of claim 9, further comprising:
an output shaft rotatably supported by the housing and configured to support the output device; and
a fan fixedly coupled to the output shaft;
wherein the BLDC motor is positioned between the fan and the battery receiving portion along a direction of the output axis.

15. The router of claim 9, wherein the battery pack has a nominal voltage of less than 21 volts, and wherein the BLDC motor is configured to output at least 1800 W in response to receiving power from the battery pack.

16. A router comprising:
a motor unit including
a housing including a battery receiving portion configured to selectively and removably couple to a battery pack, and
a brushless direct current (BLDC) motor situated within the housing and configured to provide rotational energy to rotate an output device of the motor unit about an output axis; and
a base configured to removably receive the motor unit and support the motor unit above a workpiece, the base including a first lower base portion and an annular sleeve;
wherein the battery pack has a nominal voltage of less than 21 volts, and wherein the BLDC motor is configured to output at least 1800 W in response to receiving power from the battery pack.

17. The router of claim 16, wherein the BLDC motor includes a stator and a rotor surrounded by the stator, and wherein the stator defines an outer diameter that is less than or equal to 60 millimeters.

18. The router of claim 16, further comprising:
an output shaft rotatably supported by the housing and configured to support the output device; and
a fan fixedly coupled to the output shaft;
wherein the BLDC motor is positioned between the fan and the battery receiving portion along a direction of the output axis.

19. The router of claim 16, wherein the housing includes a lower housing portion coupled to an upper housing portion, the lower housing portion including an open end, a partially closed end opposite the open end, and a cylindrical wall extending between the open end and the partially closed end, and wherein the lower housing portion defines an internal cavity, and wherein the BLDC motor is positioned within the internal cavity and surrounded by the cylindrical wall.

20. The router of claim 19, wherein the lower housing portion includes a screw boss that protrudes inwardly from the cylindrical wall, and wherein the BLDC motor includes a stator that abuts the screw boss.

21.-122. (canceled)
